(19) United States
(12) Patent Application Publication
(10) Pub. No.: US 2025/0206543 A1
(43) Pub. Date: Jun. 26, 2025

(54) SYSTEMS AND METHODS FOR INTELLIGENTLY ROUTING LINKED OBJECTS IN AN END-TO-END CONVEYER ASSEMBLY

(71) Applicant: Optum, Inc., Minnetonka, MN (US)

(72) Inventors: Aaron M. KURNETA, Chandler, AZ (US); Warren Thomas ROBERTS, Phoenix, AZ (US); Holmberg LOPEZ, Bonsall, CA (US); Michael L. MAHAR, Tempe, AZ (US); Anthony HOPPER, Overland Park, KS (US)

(21) Appl. No.: 19/000,043

(22) Filed: Dec. 23, 2024

Related U.S. Application Data
(60) Provisional application No. 63/614,757, filed on Dec. 26, 2023.

(51) Int. Cl. B65G 43/08

(52) U.S. Cl. CPC B65G 43/08

(57) ABSTRACT

Embodiments of the present disclosure provide techniques and systems for intelligently routing linked objects. One technique may include receiving, at a conveyer assembly, a first carrier container pair. The first carrier container pair may be moved, responsive to a first distance-based stimulus, to a first recirculation system within a first transportation portion of the conveyer assembly. The first recirculation system may recirculate the first carrier container pair until a first distance threshold is achieved. Responsive to a second distance-based stimulus, the first carrier container pair may be moved to a second recirculation system within a second transportation portion of the conveyer assembly. The second recirculation system may recirculate the first carrier container pair until a second distance-based stimulus is achieved. The first carrier container pair and a second carrier container pair may then be moved to a packaging portion of the conveyer assembly based on the second distance threshold.

### CROSS-REFERENCE TO RELATED APPLICATIONS

This application claims the benefit of U.S. Provisional Application No. 63/614,757, entitled “Systems and Methods for Intelligently Routing Linked Objects in an End-to-End Conveyer Assembly,” and filed Dec. 26, 2023, the entire contents of which are herein incorporated by reference.

### BACKGROUND

Various embodiments of the present disclosure address technical challenges related to high-volume logistics systems, such as those used for the fulfillment of pharmaceutical orders. Traditionally, high-volume logistics systems may leverage various conveyer assemblies to transport objects, such as pill vials in a pharmaceutical system, between different locations within a fulfillment system. In pharmaceutical systems or other systems that transport small items, such as vials, the movement of the items may be facilitated by placing the items into larger containers to improve the stability of the items as they are moved by a conveyer assembly. As one example, in a pharmaceutical system, a vial may be placed within a larger object, such as circular puck, to improve the vial's stability (and/or allow for tracking, among other advantages) as it is moved, filled, and/or otherwise transferred from an empty pill vial to a filled pill vial ready for dispatch to an end user.

Traditionally, fulfillment systems may not be configured to group or track items or objects associated with a same order as the items or objects travel through the fulfillment system. Accordingly, multiple items for a single order may be physically separated as they travel throughout the fulfillment system, which may result in one or more processing inefficiencies. For example, the fulfillment system may output the items for the same order at different times, which may result in additional sorting operations being performed prior to shipping (e.g., to collect or pair the items for the same order). Performing such sorting operations may result in increased cycle time and increased utilization of workforce resources, which may be undesirable.

### BRIEF SUMMARY

Various embodiments of the present disclosure provide techniques and systems for improving efficiency and reducing costs associated with the operation of a fulfillment system, such as a pharmaceutical fulfillment system. In accordance with one or more examples as described herein, a fulfillment system may be equipped with one or more components that improve sorting, tracking, and conveyance of orders. In some examples, the fulfillment system may additionally or alternatively include one or more recirculation systems (e.g., holding systems, reordering systems), which may enable items associated with a same order (e.g., item containers, container carriers) to be reordered (e.g., incrementally reordered) and ultimately located adjacent to one another prior to being output by the fulfillment system. Such reordering of items associated with a same order may reduce operational costs and improve processing efficiency. For example, reordering and locating items associated with a same order adjacent to one another prior to out putting the items may eliminate the need for items to be manually reordered subsequent to being output by the fulfillment system.

In some embodiments, a method includes receiving, at a conveyer assembly comprising a first transportation portion, a second transportation portion, and a packaging portion, a first carrier container pair associated with a distribution package and comprising a container carrier and an item container disposed within an interior portion of the container carrier; responsive to a first distance-based stimulus associated with the first transportation portion of the conveyer assembly, moving, using the first transportation portion of the conveyer assembly, the first carrier container pair to a first recirculation system within the first transportation portion of the conveyer assembly to recirculate the first carrier container pair until a first distance threshold is achieved; responsive to a second distance-based stimulus associated with the second transportation portion of the conveyer assembly, moving, using the second transportation portion of the conveyer assembly, the first carrier container pair to a second recirculation system within the second transportation portion of the conveyer assembly to recirculate the first carrier container pair until a second distance threshold is achieved; and moving the first carrier container pair and a second carrier container pair associated with the distribution package to the packaging portion of the conveyer assembly based on the second distance threshold.

In some embodiments, a system includes an induction system configured to: load, at a first time, a first item container into a first container carrier of a plurality of container carriers to create a first carrier container pair associated with an order, load, at a second time, a second item container into a second container carrier of the plurality of container carriers to create a second carrier container pair that is (i) associated with the order and (ii) spatially separated from the first carrier container pair by a first distance that exceeds a first distance threshold; and a conveyer assembly comprising: a first transportation portion coupled with the induction system and comprising a first recirculation system, wherein the first transportation portion is configured to, responsive to a first distance-based stimulus, move the first carrier container pair to the first recirculation system until the first distance threshold is achieved, and a second transportation portion coupled with the first transportation portion and comprising a second recirculation system, wherein the second transportation portion is configured to, responsive to a second distance-based stimulus, move the second carrier container pair to the second recirculation system until the second distance threshold is achieved.

In some embodiments, a conveyer assembly includes a first transportation portion comprising a first recirculation system and configured to: receive a first carrier container pair associated with a distribution package and comprising a container carrier and an item container disposed within an interior portion of the container carrier; and responsive to a first distance-based stimulus, move the first carrier container pair to the first recirculation system to recirculate the first carrier container pair until a first distance threshold is achieved; a second transportation portion comprising a second recirculation system and configured to: responsive to a second distance-based stimulus, move the first carrier container pair to the second recirculation system to recirculate the first carrier container pair until a second distance threshold is achieved; and a packaging portion configured to receive the first carrier container pair and a second carrier container pair associated with the distribution package based on the second distance threshold.

### BRIEF DESCRIPTION OF THE DRAWINGS

FIG. 1 provides an example overview of a system that can be used to practice embodiments of the present disclosure.

FIG. 2 provides an example computing entity in accordance with some embodiments discussed herein.

FIG. 3 provides an example external computing entity in accordance with some embodiments discussed herein.

FIG. 4 provides an example fulfillment system in accordance with some embodiments discussed herein.

FIG. 5 provides an example reordering system in accordance with some embodiments discussed herein.

FIG. 6 is a flowchart showing an example of a distance optimization process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts can be used to perform other types of data analysis.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hard ware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE SYSTEM FRAMEWORK

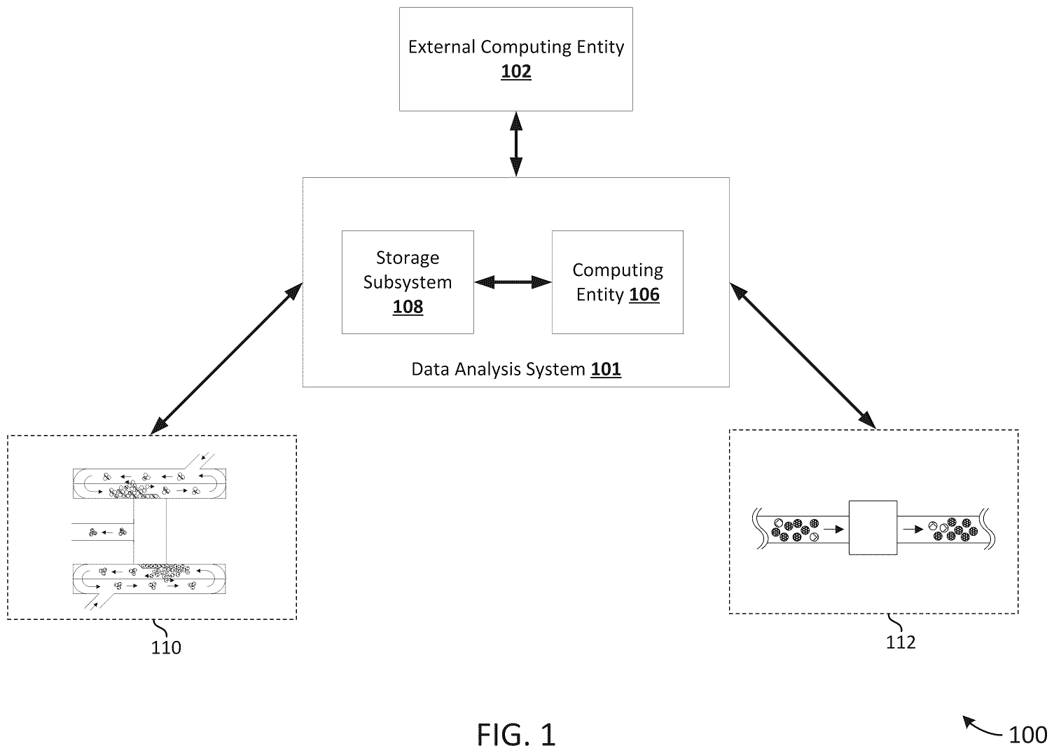

FIG. 1 provides an example overview of a system 100 that can be used to practice embodiments of the present disclosure. The system 100 includes a data analysis system 101 comprising a computing entity 106 configured to generate outputs that can be used to perform one or more output-based actions. The data analysis system 101 may communicate with one or more external computing entities 102, one or more continuous flow systems 110, and one or more reordering systems 112 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the data analysis system 101. The computing entity 106 may be in communication with one or more external computing entities 102. In one example, the computing entity 106 may be configured to generate a prediction, classification, and/or any other data insight based on data provided by an external computing entity such as external computing entity 102.

The computing entity 106 may be configured to receive requests and/or data from the one or more external computing entities 102, process the requests and/or data to generate outputs (e.g., predictive outputs, classification outputs, and/or the like), and provide the outputs to at least one of the external computing entities 102. In some embodiments, the external computing entity 102, for example, periodically updates/provides raw and/or processed input data to the data analysis system 101. The external computing entities 102 may further generate user interface data (e.g., one or more data objects) corresponding to the outputs and may provide (e.g., transmit, send, and/or the like) the user interface data corresponding with the outputs for presentation to the external computing entity 102 (e.g., to an end-user).

The storage subsystem 108 may be configured to store at least a portion of the data utilized by the computing entity 106 to perform one or more steps/operations and/or tasks described herein. The storage subsystem 108 may be configured to store at least a portion of operational data and/or operational configuration data including operational instructions and parameters utilized by the computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In accordance with one or more examples as described herein, the system 100 may be an example of a fulfillment system for processing and otherwise filling orders, such as pharmaceutical orders. The system 100 may include one or more components that decrease cycle time, reduce operational costs, and otherwise improve sorting and tracking of orders. For example, the system 100 may include one or more reordering systems 112, which may enable item containers (e.g., vials) associated with a same order to be reordered and ultimately located adjacent to one another prior to being output by the system 100. Such reordering of item containers associated with a same order may reduce operational costs and improve processing efficiency. For example, reordering and locating item containers associated with a same order adjacent to one another prior to outputting the item containers may eliminate the need for item containers to be manually reordered subsequent to being output from the system 100. Additionally, or alternatively, the reordering system 112 may enable item containers associated with a same order to be incrementally reordered as they are conveyed throughout the system 100 (e.g., at times when other operations or tasks could not be performed), which may improve efficiency of the system 100.

In some examples, a reordering system 112 may include one or more portions of a conveyer assembly, one or more holding systems, and one or more sensing systems. In one example, a plurality of container carriers (e.g., pucks) may be transported along a conveyer. A first container carrier of the plurality of container carriers may include a first item container and a second container carrier of the plurality of container carriers may include a second item container. The first item container and the second item container may be associated with a same order. The first container carrier and the second container carrier may be separated by a first distance. Additionally, the first container carrier and the second container carrier may be separated by one or more intervening container carriers carrying item containers associated with different orders. The first container carrier, the second container carrier, or both, may then be moved to a holding system, where one or more of the first container carrier or the second container carrier may be recirculated for a duration (e.g., until a distance threshold is achieved). The holding system may then output the first container carrier, the second container carrier, or both, such that the first container carrier and the second container carrier are separated by a second distance less than the first distance. In some examples, the reordering system 112 may include multiple holding systems, such that a distance between container carriers associated with a same order may be incrementally decreased as the container carriers are conveyed throughout the system 100.

### Example Computing Entity

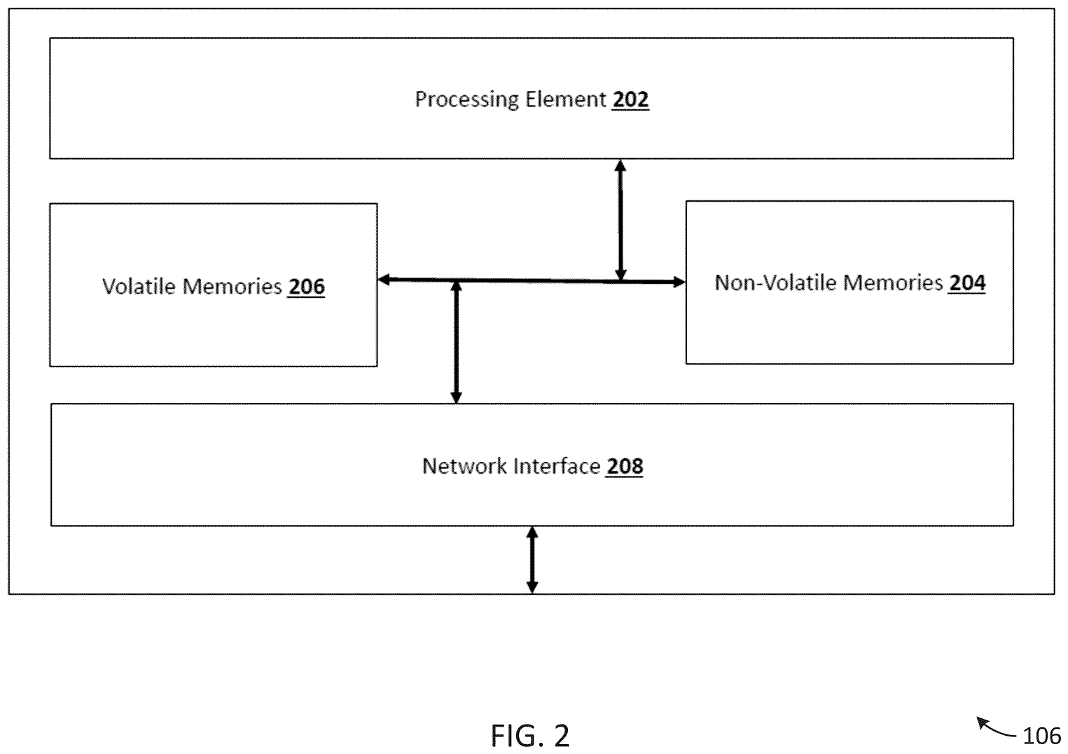

FIG. 2 provides an example computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The computing entity 106 may include a network interface 208 for communicating with various computing entities, such as by communicating data, content, information, and/or similar terms used herein interchangeably that can be transmitted, received, operated on, processed, displayed, stored, and/or the like.

In one embodiment, the computing entity 106 may include or be in communication with a processing element 202 (also referred to as processors, processing circuitry, and/or similar terms used herein interchangeably) that communicate with other elements within the computing entity 106 via a bus, for example. As will be understood, the processing element 202 may be embodied in a number of different ways including, for example, as at least one processor/processing apparatus, one or more processors/processing apparatuses, and/or the like.

For example, the processing element 202 may be embodied as one or more complex programmable logic devices (CPLDs), microprocessors, multi-core processors, coprocessing entities, application-specific instruction-set processors (ASIPs), microcontrollers, and/or controllers. Further, the processing element 202 may be embodied as one or more other processing devices or circuitry. The term circuitry may refer to an entirely hardware embodiment or a combination of hardware and computer program products. Thus, the processing element 202 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 202 may be configured for a particular use or configured to execute instructions stored in one or more memory elements including, for example, one or more volatile memories 206 and/or non-volatile memories 204. As such, whether configured by hardware or computer program products, or by a combination thereof, the processing element 202 may be capable of performing steps or operations according to embodiments of the present disclosure when configured accordingly. The processing element 202, for example in combination with the one or more volatile memories 206 and/or or non-volatile memories 204, may be capable of implementing one or more methods or computer-implemented methods as described herein. In some implementations, the computing entity 106 can include a computing apparatus, the processing element 202 can include at least one processor of the computing apparatus, and the one or more volatile memories 206 and/or non-volatile memories 204 can include at least one memory including program code. The at least one memory and the program code can be configured to, upon execution by the at least one processor, cause the computing apparatus to perform one or more steps/operations described herein.

The non-volatile memories 204 (also referred to as non-volatile storage, memory, memory storage, memory circuitry, media, and/or similar terms used herein interchangeably) may include at least one non-volatile memory device 204, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) can include at least one volatile memory 206 device, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 206 may be used to store at least portions of the databases, database instances, database management systems, data, applications, programs, program modules, scripts, source code, object code, byte code, compiled code, interpreted code, machine code, executable instructions, and/or the like being executed by, for example, the processing element 202. Thus, the databases, database instances, database management systems, data, applications, programs, program modules, scripts, source code, object code, byte code, compiled code, interpreted code, machine code, executable instructions, and/or the like may be used to control certain embodiments of the operation of the computing entity 106 with the assistance of the processing element 202.

As indicated, in one embodiment, the computing entity 106 may also include the network interface 208 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibrec, Bluetooth protocols, wireless universal serial bus (USB) protocols, and/or any other wireless protocol.

In accordance with one or more examples as described herein, the computing entity 106 may cause one or more operations to occur at one or more reordering systems 112, which may enable item containers associated with a same order to be reordered and ultimately located adjacent to one another prior to being output by the fulfillment system. For example, the computing entity 106 may transmit (e.g., via the network interface 208) a control signal that causes one or more container carriers to be moved to a holding system. In some examples, the computing entity 106 may receive information from one or more external computing entities 102 in communication with the one or more reordering systems and determine to transmit the control signal based on the information. For example, the computing entity 106 may receive an indication of a distance between two container carriers associated with a same order and may determine to transmit a control signal that causes one or more of the two container carriers to be moved to a holding system based on the distance (e.g., based on the two container carriers being separated by at least a threshold distance). The indication may be received from an external computing entity 102, which may be an example of or may be in communication with one or more sensing systems.

### Example External Computing Entity

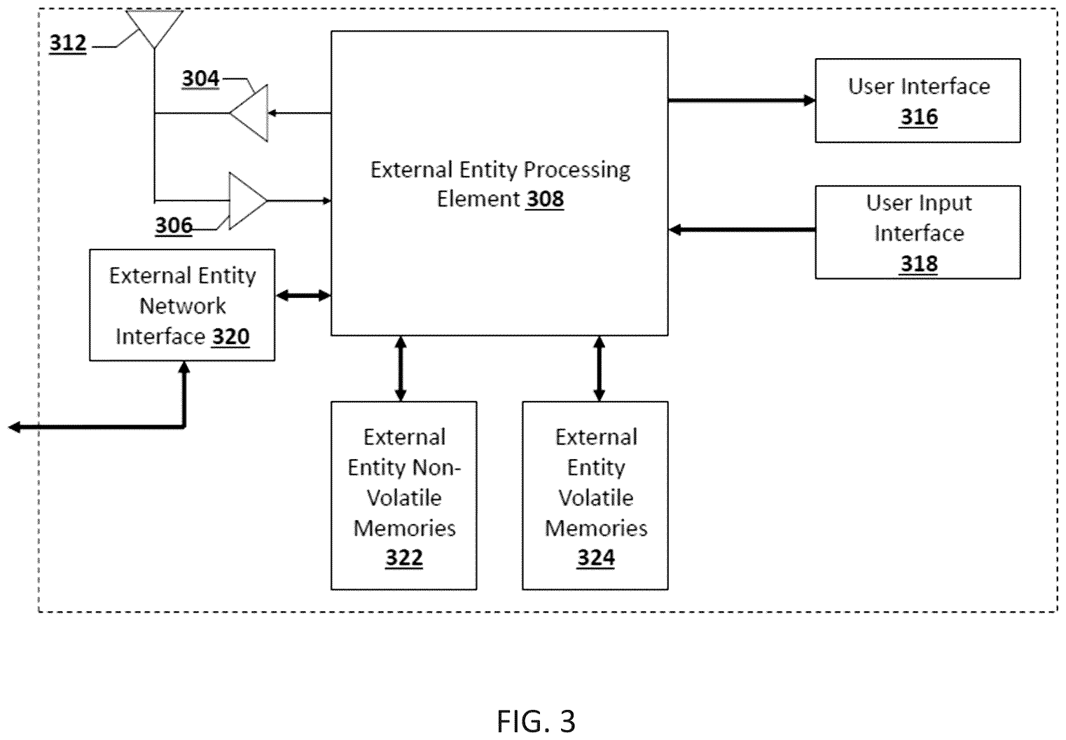

FIG. 3 provides an example external computing entity 102 in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102 can be operated by various parties. As shown in FIG. 3, the external computing entity 102 can include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference the processing element 202.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the computing entity 106 via an external entity network interface 320.

Via these communication standards and protocols, the external computing entity 102 can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), operating system, and/or the like.

According to one embodiment, the external computing entity 102 may include location determining embodiments, devices, modules, functionalities, and/or the like. For example, the external computing entity 102 may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 102 in connection with a variety of other systems, including cellular towers, Wi-Fi access points, and/or the like. Similarly, the external computing entity 102 may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 102 may include a user interface 316 (e.g., a display, speaker, and/or the like) that can be coupled to the external entity processing element 308. In addition, or alternatively, the external computing entity 102 can include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102 to interact with and/or cause the display, announcement, and/or the like of information/data to a user. The user input interface 318 can comprise any of a number of input devices or interfaces allowing the external computing entity 102 to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 102 and may include a full set of alphabetic keys or set of keys that may be activated to provide a full set of alphanumeric keys. In addition to providing input, the user input interface 318 can be used, for example, to activate or deactivate certain functions, such as screen savers, sleep modes, and/or the like.

The external computing entity 102 can also include one or more external entity non-volatile memories 322 and/or one or more external entity volatile memories 324, which can be embedded within and/or may be removable from the external computing entity 102. As will be understood, the external entity non-volatile memories 322 and/or the external entity volatile memories 324 may be embodied in a number of different ways including, for example, as described herein with reference the non-volatile memories 204 and/or the external volatile memories 206.

In some examples, the external computing entity 102 may cause one or more operations to occur at one or more reordering systems 112, which may enable item containers associated with a same order to be reordered and ultimately located adjacent to one another prior to being output by the fulfillment system. For example, the external computing entity 102 may transmit (e.g., via the external entity network interface 320) a control signal that causes one or more container carriers to be moved to a holding system. In some examples, the external computing entity 102 may receive information from computing entities 106 in communication with the one or more reordering systems and determine to transmit the control signal based on the information. For example, the external computing entity 102 may receive an indication of a distance between two container carriers associated with a same order and may determine to transmit a control signal that causes one or more of the two container carriers to be moved to a holding system based on the distance (e.g., based on the two container carriers being separated by at least a threshold distance). The indication may be received from a computing entity 106, which may be an example of or may be in communication with one or more sensing systems.

### III. EXAMPLES OF CERTAIN TERMS

In some embodiments, the term “fulfillment system” refers to a system for handling orders for items. A fulfillment system, for example, may include a plurality of logistic components for a distribution center in which items are moved, processed, and grouped in one or more packages to fulfill an order. In this respect, the logistic components may be strategically placed within the distribution center to optimize a throughput, or other logistic considerations of the fulfillment system. Logistic components, for example, may include conveyer assemblies, packaging areas, item processing areas, and/or the like that are configured to efficiently and reliably transition an item from a storage location to an end user. By way of example, a fulfillment system may include a pharmaceutical fulfillment system configured to move pharmaceutical items, such as pill vials, and/or the like, from a storage location to a package that may dispatched to an end user. A pharmaceutical fulfillment system may include various logistic components, such as conveyer assemblies, induction systems, sorting systems, vial-filling systems, and/or the like that are collectively configured to fill a pill vial and then transport the filled vial (e.g., in a puck) to a package in accordance with an order for one or more medications.

In some embodiments, the term “order” refers to a data entity that describes one or more items for an end user (e.g., an individual person, an organization, such as a pharmacy, etc.). In some examples, an order may be associated with a plurality of items that may originate at one or more different locations within the fulfillment system. To fulfill an order, the fulfillment system may group the plurality of items into a common package (e.g., a distribution package) for dispatch to the end user.

As an example, an order for a pharmaceutical fulfillment system may describe one or more different medications for an end user. In some examples, to originate an item for the order, a plurality of medications, such as pill capsules, may be loaded into one or more vials or other containers. Accordingly, an order may be associated with a plurality of vials, or other containers, that each contain a portion of the order (e.g., one of the one or more different medications). To fulfill an order, the pharmaceutical fulfillment system may group the plurality of vials into a common package for dispatch to the end user.

In some embodiments, the term “distribution package” refers to a package, parcel, or box that includes one or more item containers for dispatch (e.g., shipping) to an end user. A distribution package may be loaded with the one or more item containers by a system, component, or portion of a fulfillment system or a conveyer assembly of a fulfillment system. For example, a packaging portion of a conveyer assembly may include one or more components for filling or otherwise loading item containers into distribution packages. As described herein, distribution packages may be filled manually or using automated package filling equipment.

As one example, a distribution package for a pharmaceutical fulfillment system may include a plurality of pill vials. Each pill vial of the plurality of pill vials may be associated with a same order. In accordance with some examples described herein, the operation of a fulfillment system may be optimized using various techniques to deliver item containers associated with a same order to a distribution package within a given time range. For example, various recirculation systems (e.g., reordering systems, reorganization systems) may be utilized to group or otherwise reduce spacing between item containers associated with a same order. Accordingly, the item containers may be adjacent to one another when delivered to the packaging portion of the conveyer assembly and may be loaded into a distribution package more quickly than in traditional systems where item containers are separated upon delivery to the packaging portion of the conveyer assembly.

In some embodiments, the term “end user” refers to an originator of an order. An entity may be an individual (e.g., patient, customer, etc.), a business (e.g., pharmacy, clinic, etc.), and/or the like. An end user may be associated with a physical location to which a plurality of different item containers may be delivered to fulfil an order.

In some embodiments, the term “item container” refers to a physical object with an interior portion defined by a plurality of exterior walls. The object may be designed to contain one or more items. An item container, for example, may include a package, tote, box, tube, and/or the like for containing a plurality of items in a common space. In some examples, an item container may define a closed interior portion to contain the plurality of items in a closed environment.

As an example, in a pharmaceutical fulfillment system, an item container may include a vial, such as a pill vial for holding a plurality of pill capsules. A vial, for example, may include a cylindrical container with curved side walls, a floor, and a removeable cap disposed opposite to the floor that defines an interior portion of the vial. As described herein, the interior portion of the vial may be at least partially filled with a plurality of items, such as pill capsules, to group and then collectively move the plurality of items across the pharmaceutical fulfillment system.

In some examples, an item container, such as a pill vial, may include a small item that may be unstable (e.g., subject to falling, rolling, etc.) and/or difficult to track across a fulfillment system. In accordance with some embodiments of the present disclosure, to improve the stability and/or trackability of an item container as it is moved across the fulfillment system, an item container may be temporarily placed at least partially within an interior portion of another, larger object. For instance, an item container may be placed within a container carrier.

In some embodiments, the term “container carrier” refers to a physical object with an interior portion defined by one or more interior walls and an exterior portion defined by one or more of exterior walls. A container carrier, for example, may include an interior portion that is compatible with an item container. For example, a diameter, length, and/or the like of the interior portion may be based on a diameter, length, and/or the like of an item container such that the item container may be placed within the interior portion. In addition, or alternatively, the container carrier may include an exterior portion that is larger than the item container to add stability to the item container as it traverses through a fulfillment system. A container carrier, for example, may be used to hold, support, and/or the like one or more item containers.

By way of example, a container carrier may include a transportation puck that is compatible with a vial. A transportation puck may include cylindrical exterior and/or interior portions. For instance, the transportation puck may be cylindrical and may include a cylindrical cavity (e.g., the interior portion) where a vial may be placed. In this respect, a diameter of the interior portion may be based on a diameter of a vial. In some other examples, a transportation puck may include a plurality of cylindrical cavities, where each cylindrical cavity may hold a respective vial. Although some pucks may be cylindrical, other puck geometries may be utilized. For example, a puck may be rectangular or square.

In some embodiments, a container carrier includes one or more tracking mechanisms for identifying a location of the container carrier (and/or an item container, a plurality of items therein, etc.) within the fulfillment system. The one or more tracking mechanisms, for example, may include one or more radio-frequency identification (RFID) tags, barcodes, and/or the like.

In some embodiments, the term “carrier container pair” refers to a container carrier with an item container placed at least partially therein. A carrier container pair may be transported across a fulfillment system to move and track an item container (and/or a plurality of items therein). In some examples, a carrier container pair may be originated by an induction system that is configured to place an item container at least partially within a container carrier.

In some embodiments, the term “induction system” refers to a component of a fulfillment system that is configured to label and then place an item container within a container carrier. An induction system, for example, may include an item container labeler, such as a vial labeler, that is configured to adhere a label to an item container that describes one or more contents (e.g., a plurality of items) within and/or assigned to the item container. By way of example, an induction system may receive an empty item container, print a label for the item container, apply the label to the item container, and then drop the item container into a container carrier for transportation to a location for filling the item container with one or more items described by the item label.

An induction system may include one or more openings for objects to enter and/or exit an interior chamber of the induction system (e.g., a labeling chamber, etc.). The one or more openings, for example, may include an ingress point and an egress point. In some examples, an item container may enter the induction system through an ingress point and exit through the egress point. In some embodiments, an ingress point is located at a top portion of an induction system and an egress point is located at a bottom portion of the induction system. An item container may enter the interior chamber of the induction system by dropping through the ingress point. In some examples, an item container may be prevented from dropping through the ingress point in the event that another item container is located within the interior chamber. For instance, a currently loaded item container may act as a barrier to the entrance of a subsequent item container. The subsequent item container may drop (e.g., based on a gravitational force, etc.) into the interior chamber as the currently loaded item container exits the interior chamber. In this manner, the interior chamber of an induction system may continuously cycle through a plurality of item containers.

In some examples, an item container may be held (e.g., using a mechanical arm, gate, trap door, etc.) within an induction chamber to apply a label to the item container. Once the label is applied, the item container may be dropped through the egress point to exit the induction chamber and allow the entrance of a subsequent item container.

In some examples, a container carrier may be positioned at a loading position relative to the induction system to receive an item container as the item container exits the induction system. By way of example, the loading position may be located below an egress point of the induction chamber such that an item container may be placed (e.g., dropped, loaded, etc.) within an interior portion of a container carrier as the item container exits the induction system.

In some embodiments, an induction system is coupled with one or more other components of a fulfillment system to facilitate a continuous movement of a plurality of item containers and container carriers relative to the induction system. The one or more other components, for example, may include one or more partitioning assemblies and/or conveyer systems collectively configured to move an item container to an ingress point and a container carrier to an egress point of an induction system. For example, an item container and/or container carrier may be continuously moved by a conveyer system and directed to an ingress and egress point of an induction system by a partitioning assembly. For example, a partitioning assembly (and/or one or more partitioning walls thereof) may cause a formation of a queue of item containers adjacent to an ingress point of an induction system. As additional item containers are directed into the queue, one or more item containers in the queue may be pushed into the induction chamber (e.g., by another item container, the conveyer, or both).

In some embodiments, the term “partitioning wall” refers to a component of a fulfillment system that is used for routing or directing a movement of an object. In some examples, a partitioning wall may be fixed (e.g., a partitioning wall may not move or have any moving parts). In addition, or alternatively, a partitioning wall may be movable (e.g., include a hinge, etc.). A partitioning wall may be an example of a type of routing device, such as a mechanical routing device, which may be different from some other types of routing devices (e.g., electronically controlled routing devices). A partitioning wall may route or otherwise direct an object, such as an item container and/or container carrier, from a first component of a fulfillment system (e.g., a recirculation system) to a second component of a fulfillment system (e.g., an induction chamber).

In some examples, a partitioning wall may direct an object as it is moved by conveyer assembly. For example, a partitioning wall may adjust or alter a path of an object as the object travels along a conveyer. In some examples, a partitioning wall may route an object from one conveyer to another conveyer (e.g., from a first portion of a conveyer assembly to a second portion of a conveyer assembly). In some examples, two or more partitioning walls may be utilized (e.g., in conjunction with one another) to route an object.

In some embodiments, the term “partitioning assembly” refers to one or more partitioning walls utilized to route, redirect, and/or the like an object with respect to another component of a fulfillment system. In some examples, a partitioning assembly may include one or more partitioning walls that are located relative to one another to direct an object's direction of movement. A partitioning assembly, for example, may include one or more partitioning walls relative to an induction system that are configured to direct an object to an ingress or egress point of the induction system. A partitioning assembly, for example, may include carrier partitioning assembly that is positioned on a conveyer assembly (e.g., a carrier recirculation system) to direct a container carrier to a loading position for one or more induction systems. In addition, or alternatively, a partitioning assembly may include a container partitioning assembly that is positioned on a conveyer assembly (e.g., a container recirculation system) to direct an item container to an ingress point for one or more induction systems. As described herein, a plurality of partitioning assemblies may be strategically placed at one or more locations of a conveyer assembly to leverage a continuous movement of a plurality of item containers and container carriers for positioning the containers and carriers with respect to one or more induction systems without stopping an operation of the conveyer assembly.

In some embodiments, the term “conveyer assembly” refers to a component of the fulfillment system that is configured to move (e.g., through friction or other forces) item containers, container carriers, and/or the like to, from, and/or between one or more locations within the fulfillment system. In some examples, a conveyer assembly may include an assembly, arrangement, system, and/or the like that includes a plurality of conveyers. In some examples, a conveyer assembly may include an end-to-end closed conveyance system that is configured to transport (e.g., move, route, etc.) a plurality of objects (e.g., item containers, container carriers, combinations thereof, etc.) between one or more points within a fulfillment system. The conveyer assembly may include a plurality of at least partially connected portions, each configured to move a plurality of objects (e.g., item containers, container carriers, combinations thereof, etc.) to, from, and/or between multiple points within the fulfillment system. In some examples, one or more portions of the conveyer assembly may be connected by one or more other systems, such as an induction system, as described herein.

In some embodiments, a conveyer assembly includes a plurality of portions that respectively correspond to one or more areas within a fulfillment system. For instance, each portion may include one or more conveyers that are configured to move an object, directly or indirectly, from an origin location to a destination location associated with a respective area. To do so, each of the one or more portions of the conveyer assembly may include one or more recirculation and/or direct conveyer systems.

As described herein, a recirculation conveyer system may include an at least partially looped conveyer in which an object may complete one or more recirculation cycles without moving from a portion of the conveyer assembly. A direct conveyer system may include a directed section of conveyer that moves an object from an origin to a destination location. An object may be moved between portions of the conveyer assembly using a direct conveyer system. For example, a direct conveyer system may include an induction exiting system configured to move an item container, a container carrier, and/or one or more combinations thereof from an induction system to a subsequent portion of a conveyer assembly.

Various embodiments described herein provide a conveyer assembly that provides advantages when compared to conventional conveyer systems. For example, the conveyer assembly may be configured to facilitate more efficient, effective, and accurate processing of connected orders, such as pharmaceutical orders, in which a plurality of objects (e.g., item containers) are aggregated, transported, and collectively packaged for a single end user. For example, the conveyer assembly described herein may include one or more components that decrease cycle time, reduce operational costs, and otherwise improve sorting and tracking of orders. To do so, the conveyer assembly may include one or more continuous flow systems (e.g., recirculation systems) that enable objects (e.g., item containers) associated with an order to be grouped prior to reaching an endpoint of the fulfillment system.

In some embodiments, the term “conveyer” refers to a component of the conveyer assembly. A conveyer may include one or more moving surfaces (e.g., one or more belts, one or more rollers, etc.), which may exert one or more directional forces on one or more objects placed on the conveyer. In some examples, a conveyer may be controlled by a control system. It should be understood that a conveyer or conveyer belt, as described herein, may be configured as a conventional conveyer belt, such that it is formed and/or extended around at least two driving wheels. By turning the driving wheels, the conveyer belt may run cyclically (e.g., continuously around the driving wheels). The conveyer belt may thus, like conventional belts of this nature, be made from a multitude of materials, linkages, and so forth, so as to achieve a desired combination of durability and flexibility thereof.

In some embodiments, the term “transportation portion” refers to a portion of a conveyer assembly that corresponds to one or more areas within a fulfillment system. A transportation portion may include one or more conveyers (e.g., direct conveyer systems, recirculation conveyer systems, or both) as well as one or more systems that perform various operations for processing item containers, container carriers, or carrier container pairs. In one example, a pharmaceutical fulfillment system may include multiple transportation portions.

In some embodiments, the term “filling transportation portion” refers to a portion of a conveyer assembly that includes one or more components for filling item containers with one or more items. For example, a filling transportation portion may include one or more filling systems configured to fill an item container, such as a pill vial, with one or more target objects, such as pill capsules. A filling transportation portion may include the one or more components for filling the item containers, one or more sensing systems for sensing various characteristics of container carriers, and/or one or more holding systems for holding or recirculating one or more carrier container pairs. Additionally, or alternatively, a filling transportation portion may include one or more conveyers (e.g., direct conveyer systems, recirculation conveyer systems, or both), which may move objects throughout the filling transportation system. As one illustrative example, a holding system may include a recirculation system, which may be configured to recirculate one or more carrier container pairs within the filling transportation portion. In some examples, a filling transportation portion may be coupled with one or more other components of a fulfillment system, such as an induction system (e.g., via a sorting system) and a bridge transportation portion.

In some embodiments, the term “bridge transportation portion” refers to a portion of a conveyer assembly that includes one or more components (e.g., a bridge system including one or more conveyers, among other examples of components included in the bridge transportation portion) for moving carrier container pairs from a filling transportation portion of a fulfillment system to a verification transportation portion (and/or other portions) of a fulfillment system. For example, a bridge transportation portion may include a bridge system. The bridge system may include one or more direct conveyer systems configured to transport one or more carrier container pairs from the filling transportation portion to the verification transportation portion. Additionally, or alternatively, the bridge transportation portion may include one or more sensing systems for sensing various characteristics of container carriers and/or one or more holding systems for holding or recirculating one or more carrier container pairs. In some examples, the bridge transportation portion may include one or more recirculation conveyer systems, which may be configured to recirculate one or more carrier container pairs within the bridge transportation portion. For example, a holding system of a bridge transportation portion may include one or more recirculation conveyer systems. In some examples, the bridge transportation portion may be coupled with one or more other components of a fulfillment system, such as a filling transportation portion and a verification transportation portion.

In some embodiments, the term “verification transportation portion” refers to a portion of a conveyer assembly that includes one or more components, such as a verification system, for verifying one or more characteristics of one or more items in the verification transportation system. For example, a verification system of a verification transportation portion may include one or more components for determining if a correct item has been loaded into a respective item container, among other examples. In some examples, a verification system may include one or more inspection stations where one or more carrier container pairs may be temporarily held for manual or automatic inspection. In some examples, the verification system may be configured to verify one or more characteristics of an order. For example, the verification system may be configured to verify if two or more carrier container pairs associated with a same order are adjacent to one another, or if each carrier container pair associated with an order is present (e.g., in the verification transportation portion).

The verification transportation portion may include the verification system, one or more conveyer systems, one or more sensing systems, and one or more holding systems. The one or more sensing systems may be configured to sense various characteristics of container carriers and the one or more holding systems may be configured to hold or recirculate one or more carrier container pairs. In some examples, the verification transportation portion may include one or more recirculation conveyer systems, which may be configured to recirculate one or more carrier container pairs within the verification transportation portion. For example, a holding system of a verification transportation portion may include one or more recirculation conveyer systems. In some examples, the verification transportation portion may be coupled with one or more other components of a fulfillment system, such as a bridge transportation portion and a packaging transportation portion.

In some embodiments, the term “packaging transportation portion” refers to a portion of a conveyer assembly that includes one or more components for delivering or packaging carrier container pairs. For example, the packaging transportation portion may include a delivery system, which may be a destination location for one or more item containers. A delivery system may be configured to manually or automatically load one or more item containers into a distribution package. Additionally, or alternatively, the packaging transportation portion may include one or more conveyer systems, which may be configured to move one or more carrier container pairs, one or more item containers (e.g., once removed from respective container carriers), and/or one or more container carriers (e.g., once respective item containers are removed). In some examples, the packaging transportation portion may include one or more components, such as the delivery system, for removing item containers from container carriers. In some examples, the packaging transportation portion may be coupled with one or more other components of a fulfillment system, such as a verification transportation portion and a carrier source (e.g., the packaging transportation portion may route empty container carriers back to the carrier source).

In some embodiments, the term “recirculation system” refers to a configuration of conveyers within a portion of a conveyer assembly that transports, conveys, etc. an object along a looped (e.g., continuous) path. Stated another way, a recirculation system may transport an object from an origin location to one or more other points and then back to the origin location. An object in a recirculation system may follow a circular path or an irregular, non-circular path. To do so, a recirculation system may have one of one or more different configurations. A first configuration may include a plurality of conveyers placed at one or more angles to collectively form a looped path. For example, one or more direct conveyer systems may be arranged in a contiguous shape (e.g., a circle, square, rectangle, etc.), such that an object may be conveyed around a perimeter of the shape for a number of recirculation cycles. One or more additional conveyers may be coupled with the direct conveyer systems to move objects onto and off of the looped path.

In addition, or alternatively, a second configuration may include two sets of conveyers that move in opposite directions. For instance, the second configuration may include a first set of linear conveyers and a second set of linear conveyers that may apply opposite directional forces to objects disposed on a surface of the respective sets of linear conveyers. The first set of conveyers may be adjacent to the second set of conveyers such that an object may be moved (e.g., by making contact with a partition, by one or more looped conveyers, etc.) from the first set of conveyers to the second set of conveyers. The first set of conveyers may be configured to transport objects in a first direction and the second set of conveyers may be configured to transport objects in a second direction parallel to and opposite of the second direction to form a continuous loop.

In one illustrative example of the second configuration, an object may travel on the first set of conveyers in the first direction until the object is slid or is pushed (e.g., by another object, by a partitioning wall, by one or more looped conveyers, etc.) onto the second set of conveyers. The second set of conveyers may then move the object in the second, opposite direction. In such examples, the object may be said to recirculate by way of switching from the first set of conveyers to the second set of conveyers and reversing direction. In some examples, the object may recirculate or otherwise switch between conveyers continuously until the object is moved from both sets of conveyers.

In some embodiments, a recirculation system includes one or more entry and/or exit points. For example, an object may be moved to a recirculation system (e.g., onto a conveyer surface of the recirculation system, etc.) via an entry point and may be moved from the recirculation system via an exit point. An entry point, for example, may include a gate (e.g., a mechanical gate, an electronic gate, etc.), a partitioning wall, and/or the like that may be controlled and/or configured to direct an object to a recirculation system. An exit point may include a gate (e.g., a mechanical gate, an electronic gate, etc.), a partitioning wall, and/or the like that may be controlled and/or configured to direct an object from a recirculation system.

A conveyer assembly may include a plurality of recirculation systems of different types to continuously move objects within one or more portions of the conveyer assembly. For instance, the recirculation systems may include one or more carrier recirculation systems, one or more container recirculation systems, one or more holding systems (e.g., reordering systems, reorganizing systems), and/or the like. Each of the recirculation systems may include entry and/or exit points that are configured for a particular task. By way of example, a carrier recirculation system, such as a carrier loading system, and/or a container recirculation system may include a plurality of exit points that are respectively associated with partitioning assemblies configured to leverage a continuous motion of objects (e.g., possible by the cyclic design of the recirculation systems) within the recirculation systems to automatically position the objects to exit the recirculation systems and enter an induction system.

By way of example, a partitioning assembly relative to an exit point of a recirculation system may cause an object to be moved from of the recirculation system based on a position of the object relative to a width and/or sidewall of the recirculation system. For example, a partitioning assembly may be configured to intercept and route an object located on a portion of a conveyer of a recirculation system (e.g., located along a sidewall of the conveyer or within a certain distance from the sidewall of the conveyer) from the recirculation system (e.g., to a position relative to an induction system, etc.).

In some examples, a recirculation system may be utilized to hold (e.g., recirculate) one or more objects until a trigger event occurs (e.g., in response to a distance-based stimulus). For example, the one or more objects may be moved off of a direct conveyer system and into the recirculation system while other objects continue to move on the direct conveyer system. The occurrence of the trigger event may then cause the one or more objects to be moved back onto the direct conveyer system, which may effectively alter a position of the one or more objects with respect to other objects that continued to move on the direct conveyer system. In accordance with various examples described herein, such techniques may be employed to group objects (e.g., item containers, pill vials, etc.) associated with a same order. In some examples, multiple recirculation systems may be utilized throughout a fulfillment system to incrementally reduce a separation between objects associated with a same order, which may improve efficiency and space utilization of the fulfillment system.

In some embodiments, the term “holding system” refers to a recirculation system within a transportation portion of the fulfillment system. For instance, each transportation portion may include one or more holding systems to recirculate objects (e.g., item containers, container carriers, carrier container pairs, etc.) within the transportation portion. By recirculating the objects, a holding system may temporarily “hold” the object within a location of the transportation portion.

In some embodiments, the term “distance-based stimulus” refers to an event, catalyst, etc. that causes, triggers, etc. an object to be moved into a recirculation system, or any other type of diversion area that at least temporarily removes the object from a direct conveyer system. In some examples, the occurrence of a distance-based stimulus may be measured or identified by one or more sensing systems. For example, a sensing system may read a location tracking mechanism of a first object at a first time (e.g., when the object passes the sensing system) and read a location tracking mechanism of a second object at a second time (e.g., when the second object passes the sensing system). The sensing system may then determine a distance between the first object and the second object (e.g., based on a speed of a conveyer that moves the first object and the second object, and based on a difference between the second time and the first time). The distance between the first object and the second object satisfying (e.g., being greater than) a threshold distance may be an example of a distance-based stimulus.

In some other examples, a presence or absence of one or more objects in a zone or area may constitute a distance-based stimulus. For example, a sensing system may determine respective locations of each object associated with a same order relative to respective portions (e.g., transportation portions) of a conveyer assembly. If one or more first objects associated with the same order are located in a first portion of a conveyer assembly and one or more second objects associated with the same order are located in a second portion of the conveyer assembly, the one or more first objects may be moved into a recirculation system included in the first portion of the conveyer assembly until the one or more second objects enter the first portion of the conveyer assembly.

In some examples, a distance between two objects being greater than a threshold may constitute a distance-based stimulus. For example, a first object may be separated from a second object by a first distance that is greater than a first distance threshold. In response to the first distance being greater than the first distance threshold, the first object or the second object may be moved to a first recirculation system (e.g., included in a first portion of a conveyer assembly) until the first distance threshold is achieved (e.g., until the first object and the second object are separated by the first distance threshold). In some examples, the first object and the second object may then be separated by a second distance that is less than the first distance. However, the second distance may be greater than a second distance threshold. Accordingly, the first object or the second object may be moved to a second recirculation system (e.g., included in a second portion of a conveyer assembly) until a second distance threshold is achieved (e.g., until the first object and the second object are separated by the second distance threshold). The second distance threshold may be less than the first distance threshold.

In some embodiments, the term “presence data” refers to data that is indicative of a container carrier (e.g., a carrier identifier). In some examples, presence data may be raw data. In some other examples, presence data may be encoded data. Presence data may be processed to generate and/or identify an identifier for a container carrier. A container carrier may be detected based on a container carrier identifier. In response to the detection of a container carrier, a location of the container carrier may be updated to a relative location of the sensing system that generated the presence data. The relative location may be stored in a location log with a timestamp.

In some examples, a distance between two container carriers may be determined by comparing locations of the two container carriers in the location log (e.g., past locations with timestamps). In some examples, a location stored in a location log may correspond to a portion of the conveyer assembly (e.g., a portion of the conveyer assembly where the sensing system that detected the presence data is located). For example, a conveyer assembly may include at least one sensing system within each portion of the conveyer assembly. In some examples, each transportation portion of the conveyer assembly may include a sensing system disposed relative to at least one of an ingress and/or egress point of the transportation portion. In this way, the detection of a container carrier may be indicative of whether a container carrier is located within a respective transportation portion.

In some embodiments, the term “recirculation cycle” refers to a movement of an object from an origin location back to the origin location. A recirculation cycle may be completed as an object is moved by an at least partially circular set of conveyers. In addition, or alternatively, a recirculation cycle may be completed by changing a direction of motion of an object by transferring the object between two conveyers operating in opposite directions. By way of example, a recirculation cycle may include one or more changes in a conveyance direction of an object in a recirculation system. For instance, a recirculation cycle may be associated with or correspond to an object moving from a first conveyer (e.g., conveying the object in a first direction) to a second conveyer (e.g., conveying the object in a second direction). An object may complete a recirculation cycle if the object changes direction one or more times to move from an origin location back to the origin location.

In some embodiments, the term “container recirculation system” refers to a recirculation system that is designed to recirculate item containers at one or more portions of the conveyer assembly. As described herein, a container recirculation system may be configured to recirculate a plurality of item containers such that they complete one or more container recirculation cycles. In some examples, a container recirculation system may include one or more partitioning assemblies that may direct one or more of a plurality of recirculating item containers into one or more loading areas (e.g., a container loading area, etc.). By doing so, a container recirculation system may cause a continuous movement of item containers to automatically and continuously feed into one or more induction systems.

In some embodiments, the term “carrier recirculation system” refers to a recirculation system that is designed to recirculate container carriers at one or more portions of the conveyer assembly. As described herein, a carrier recirculation system may be configured to recirculate a plurality of container carriers such that they complete one or more carrier recirculation cycles. By doing so, a carrier recirculation system may cause continuous movement of container carriers, which may automatically and continuously feed the container carriers into loading positions relative to the one or more induction systems.

In some embodiments, the term “loading recirculation system” refers to a type of a carrier recirculation system. A loading recirculation system may be configured to continuously move container carriers as they are moved into loading positions relative to one or more induction systems. For example, a loading recirculation system may include one or more partitioning assemblies that may direct one or more of a plurality of recirculating container carriers into one or more loading areas (e.g., carrier loading areas, etc.).

In some examples, a loading recirculation system may exchange container carriers with another carrier recirculation system to complete a carrier recirculation cycle. For instance, a loading recirculation system may receive container carrier from one or more other components of a fulfillment system, such as a carrier source, which may form another example of a recirculation system. In some examples, a loading recirculation system may receive a plurality of container carriers from an overflow recirculation system. Additionally, or alternatively, the loading recirculation system may move one or more container carriers into the overflow recirculation system (e.g., if the one or more container carriers are not loaded into an induction system during a recirculation cycle).

In some embodiments, the term “overflow recirculation system” refers to a type of carrier recirculation system. In some examples, an overflow recirculation system may be configured to recirculate a plurality of container carriers received from one or more different portions of a conveyer assembly. For instance, the conveyer assembly may form a closed system with a plurality of container carriers that are leveraged to move item containers to a destination location of the conveyer assembly. After moving the item containers, the plurality of container carriers (e.g., now emptied) may be routed back to a carrier recirculation system to receive another item container to repeat the process. This end-to-end conveyance process may be performed without removing a container carrier from the conveyer assembly.

For example, each container carrier of the closed system conveyer assembly may be ultimately routed to an overflow recirculation system. An overflow recirculation system may continuously move the container carriers until they are needed to move item containers. An overflow recirculation system may then supply one or more loading recirculation systems with a plurality of container carriers. In a high throughput system, this may be a continuous process in which container carriers are continuously moved from an overflow recirculation system to loading recirculation system. In some examples, an overflow recirculation system may receive container carriers back from the loading recirculation system in the event that they are not loaded after a recirculation cycle.

In some embodiments, the term “continuously travel” refers to an at least partially uninterrupted movement of an object. In some examples, a conveyer may be configured to operate continuously regardless of whether objects on the conveyer are continuously in motion. For example, a belt or a roller on a conveyer may operate continuously even if one or more objects are stationary or temporarily stationary (e.g., the belt or roller may slip underneath the one or more objects without moving them). In such examples, the conveyer may continuously deliver objects to be moved off of the conveyer.

In some embodiments, the term “container availability” refers to an availability of one or more containers for loading into one or more container carriers. For example, a container may be available if the container is present at a location (e.g., within an induction system, within a loading area, within a container recirculation system, etc.). In some examples, container carriers may be moved into a recirculation system based on container availability.

In some embodiments, the term “linking an identifier” refers to associating an identifier (e.g., an identifier data object) with one or more other data objects. For example, an identifier for a container carrier may be virtually linked with an identifier for an item container to virtually associate an item container with a container carrier. In this manner, an item container and container carrier may be jointly tracked as they traverse the fulfillment system.

In some embodiments, the term “item container information” refers to information or data that is associated with an item container. The item container information may indicate one or more characteristics or parameters for an item container, such as an identifier for an item container (e.g., an item container identifier), a location of an item container (e.g., an item container location), whether or not the item container is loaded into a container carrier (e.g., an item container loading status), and whether or not an error associated with the item container has occurred (e.g., an item container error status). The item container information may be stored by a computing entity or a controller for the fulfillment system. In some examples, the item container information may be an example of a data object.

In some embodiments, the term “item container identifier” refers to a string of one or more characters that correspond to an item container. The string of one or more characters may include one or more numbers, one or more letters, or any combination thereof. In some examples, an item container identifier may be assigned to an item container when the item container is introduced into a fulfillment system (e.g., during a first phase of a fulfillment process). In some examples, an item container identifier may be stored by a computing entity. In some examples, an item container identifier may be stored by a radio-frequency identification (RFID) tag (e.g., an RFID tag of a container carrier that carries the item container).

In some embodiments, the term “item container location” refers to a position of an item container within a fulfillment system. An item container location may be a current location of an item container or a last known location of an item container. For example, a sensing system may detect the presence of an item container at a specific location (e.g., at a location of the sensing system) and an item container location data object may be updated to indicate that the item container is or was located at the specific location.

In some embodiments, the term “container loading status” refers to a data entity that identifies whether a container carrier is loaded into an item container. In some examples, a binary value may be used to indicate a container loading status. For example, a first value (e.g., “1”) may identify that an item container has been loaded into a container carrier and a second value (e.g., “0”) may indicate that an item container has not been loaded into a container carrier.

In some embodiments, the term “container error status” refers to a container loading status that identifies an error or fault associated with an item container. For example, a container error status may be indicated by a bit. A first value of the bit (e.g., “1”) may indicate that an error has occurred and a second value of the bit (e.g., “0”) may indicate that an error has not occurred. In some other examples, one or more values (e.g., a string of values) may be used to indicate a container error status. In some examples, a container error status may additionally indicate a type of error that has occurred.

In some embodiments, the term “container carrier information” refers to information or data that is associated with a container carrier. The container carrier information may indicate one or more characteristics or parameters for a container carrier, such as an identifier for a container carrier (e.g., a container carrier identifier), a location of a container carrier (e.g., a container carrier location), whether or not the container carrier is carrying an item container (e.g., a carrier loading status), and whether or not an error associated with the container carrier has occurred (e.g., a container carrier error status). The container carrier information may be stored by a computing entity or a controller for the fulfillment system. In some examples, the container carrier information may be an example of a data object.

In some embodiments, the term “container carrier identifier” refers to a string of one or more characters that correspond to a container carrier. The string of one or more characters may include one or more numbers, one or more letters, or any combination thereof. In some examples, a container carrier identifier may be assigned to a container carrier when the container carrier is introduced into a fulfillment system (e.g., during a first phase of a fulfillment process). In some examples, a container carrier identifier may be stored by a computing entity. In some examples, a container carrier identifier may be stored by an RFID tag (e.g., an RFID tag of a container carrier).

In some embodiments, the term “sorting system” refers to a component of a fulfillment system. A sorting system may automatically route carrier container pairs to one or more other components of the fulfillment system, such as one or more container-filling systems in which item containers may be filled with a respective plurality of items. For example, a sorting system may move a carrier container pair to a manual filling area (e.g., to be filled manually) and/or to an automatic filling system (e.g., to be filled using automation). A sorting system may determine where to move a carrier container pair based on a type of order that the carrier container pair is associated with. For example, some types of orders (e.g., some medication types) may be designated for manual filling and other types of orders may be designated for automatic filling. Additionally, or alternatively, a sorting system may determine where to move a carrier container pair based on availability for a filling system. In some examples, a sorting system may receive one or more control signals (e.g., from a control system), which may control the sorting system. A sorting system may have one or more openings for objects to enter or exit through. For example, carrier container pairs may be moved into a sorting system via an entry point and out of the sorting system via an exit point. A sorting system may be coupled with one or more other components of a fulfillment system, such as one or more portions of the conveyer assembly to facilitate the movement of the carrier container pairs.

In some embodiments, the term “container filling system” refers to a component of a fulfillment system. A container filling system may include one or more mechanical and/or electrical components for automatically dispersing a plurality of items into an item container. A container filling system, for example, may include a hopper for holding a plurality of specific items, a counting chamber for counting a subset of the specific items, and/or a dispensing point through which the subset of the specific items may be dispersed from the container filling system. In some examples, a container filling system may include circuitry (e.g., cameras, sensors, memory, processors, etc.) specially configured to count a specific number of items as they fall through the counting chamber. In this way, a container filling system may dispense a specific number of a items into an item container based on the order information corresponding to the item container.

In some embodiments, the term “sealing system” refers to a component of a fulfillment system. In some examples, a sealing system may be included in a portion of a conveyer assembly (e.g., a third portion of a conveyer assembly). A sealing system may be configured to adhere one or more seals to an item container, thereby sealing the item container. In some examples, a type of seal adhered to an item container may depend on the type of the item container. For example, a scaling system may apply one or more of a parafilm seal or a cap (e.g., a twist-off cap) to a pill vial. In some examples, the scaling system may apply a parafilm seal to an item container and attach a cap over the parafilm seal.

In some embodiments, the term “verification system” refers to a component of a fulfillment system. In some examples, a verification system may be included in a portion of a conveyer assembly (e.g., a fourth portion of a conveyer assembly). A verification system may be configured to verify one or more carrier container pairs, which may be associated with an order. In some examples, a verification system may include one or more components that facilitate manual inspection of one or more carrier container pairs. Additionally, or alternatively, a verification system may include one or more components that automatically perform one or more verification operations (e.g., using one or more sensing systems, without manual intervention). In one illustrative example, a verification system may include one or more components to verify a distance between two or more carrier container pairs associated with a same order prior to routing the two or more carrier container pairs to a delivery system.

In some embodiments, the term “sensing system” refers to a component of a fulfillment system. A sensing system may include circuitry (e.g., cameras, sensors, memory, processors, etc.) specially configured to detect, sense, and/or the like a presence of an object, such as item container, container carrier, and/or carrier container pair, at a particular location of the fulfillment system (e.g., a portion of the conveyer assembly). In some examples, a sensing system may be configured to detect an object by scanning information associated with the object as the object moves relative to (e.g., over, etc.) a scanning location on a conveyer assembly. For example, a sensing system include an RFID reader configured to receive one or more radio signals emitted by an object and/or a tracking mechanism thereof). By way of example, an object, such as a container carrier, may include one or more tracking mechanisms, such as an RFID tag, barcode, and/or the like. The tracking mechanism may emit an identifying radio signal that may be received by a sensing system when the object is within a proximity to the sensing system. A sensing system may be coupled with one or more components of a fulfillment system, such as one or more portions of the conveyer assembly to detect an object as it moves between or through portions of the conveyer assembly.

In some embodiments, the term “delivery system” refers to a component of a fulfillment system. A delivery system may be a destination location for an item container. At a delivery system, an item container may be manually and/or automatically loaded to a distribution package (e.g., delivery package) with one or more associated item containers. For instance, at a delivery system, an item container may be unloaded from a container carrier and placed within a distribution package for dispatching to an end user. A delivery system may be coupled with one or more other components of a fulfillment system, such as one or more portions of the conveyer assembly.

In some embodiments, the term “couple” refers to connecting one or more components. Coupling one or more components (e.g., one or more components of the fulfillment system) may include mechanically (e.g., physically) coupling the one or more components, electrically coupling the one or more components, or both. For example, a conveyer may be coupled with an induction system (e.g., a physical connection may exist between the conveyer and the induction system). A coupling may enable a container carrier to be delivered from one component of a fulfillment system to another component of the fulfillment system. Additionally, or alternatively, a coupling may enable signaling or communications to be communicated from one component of a fulfillment system to another component of the fulfillment system.

In some embodiments, the term “error” refers to a failure or a fault that is detected. For example, an error may indicate that an item container has not been successfully loaded into a container carrier. Some other examples of errors may indicate that a component has lost power, that an item container has been incorrectly loaded into a container carrier, or a tracking mechanism has not been correctly read, among other examples. An error (e.g., a message indicating the occurrence of an error) may be communicated to one or more components of a fulfillment system. In some examples, an object may be moved to one or more components of the fulfillment system based on the occurrence of an error.

### IV. OVERVIEW

Various types of fulfillment systems, such as those used for the fulfillment of pharmaceutical orders, may be utilized for packaging and delivering orders to customers. Such fulfillment systems may leverage various conveyer assemblies to transport objects, such as pill vials in a pharmaceutical system, between different locations within the fulfillment system. Such fulfillment system may additionally utilize packaging systems, labeling systems, sensor systems, control systems, and tracking systems, among other examples. In some examples, a fulfillment system may be utilized to sort, package, and deliver various types of items, such as pharmaceuticals, to end users or institutions that provide the items to consumers. Some examples of such institutions include retailers, pharmacies, and/or the like.

In some examples, fulfillment systems may process large orders that are filled using multiple item containers. For example, a single order may include two item containers filled with one or more medications. However, the two item containers associated with the single order may be separated from one another as they travel throughout the fulfillment system. Consequently, the two item containers may be output by the fulfillment system separately (e.g., at different times, at different locations). Such separation of item containers for a same order may be undesirable. For example, such separation of item containers for the same order may result in additional workforce resources being utilized to combine the item containers, which may increase cycle time and operational costs.

In some examples, a fulfillment system may additionally or alternatively include one or more reordering systems, which may enable item containers associated with a same order to be reordered and ultimately located adjacent to one another prior to being output by the fulfillment system. Such reordering of item containers associated with a same order may reduce operational costs and improve processing efficiency. For example, reordering and locating item containers associated with a same order adjacent to one another prior to outputting the item containers may eliminate the need for item containers to be manually reordered subsequent to being output from the fulfillment system. Additionally, or alternatively, reordering systems may enable item containers associated with a same order to be incrementally reordered as they are conveyed throughout the fulfillment system (e.g., at times when other operations or tasks could not be performed), which may improve efficiency of the fulfillment system.

In some examples, a reordering system may include one or more conveyers, and/or one or more sensing systems. In one example, a plurality of container carriers may be transported along a conveyer. A first container carrier of the plurality of container carriers may include a first item container and a second container carrier of the plurality of container carriers may include a second item container. The first item container and the second item container may be associated with a same order. The first container carrier and the second container carrier may be separated by a first distance. Additionally, the first container carrier and the second container carrier may be separated by one or more intervening container carriers carrying item containers associated with different orders. The first container carrier, the second both, or both, may then be moved to a holding system, where one or more of the first container carrier and the second container carrier may be circulated for a duration (e.g., until a distance threshold is achieved). The holding system may then output the first container carrier, the second container carrier, or both, such that the first container carrier and the second container carrier are separated by a second distance less than the first distance. In some examples, a reordering system may include multiple holding systems, such that a distance between container carriers associated with a same order may be incrementally decreased as the container carriers are conveyed throughout a fulfillment system.

Examples of technologically advantageous embodiments of the present disclosure include incremental reordering of item containers associated with a same order during processing, among other examples. Other technical improvements and advantages may be realized by one of ordinary skill in the art.

### V. EXAMPLE SYSTEM FRAMEWORKS AND PROCESS FLOWS

As indicated, various embodiments of the present disclosure make important technical contributions to fulfillment system technologies. In particular, systems and methods are disclosed herein that enable the tracking and incremental reordering of carrier container pairs associated with a same order. When compared to traditional techniques, the tracking and reordering techniques described herein provide increased efficiency and reduced operational costs.

### Example Fulfillment System

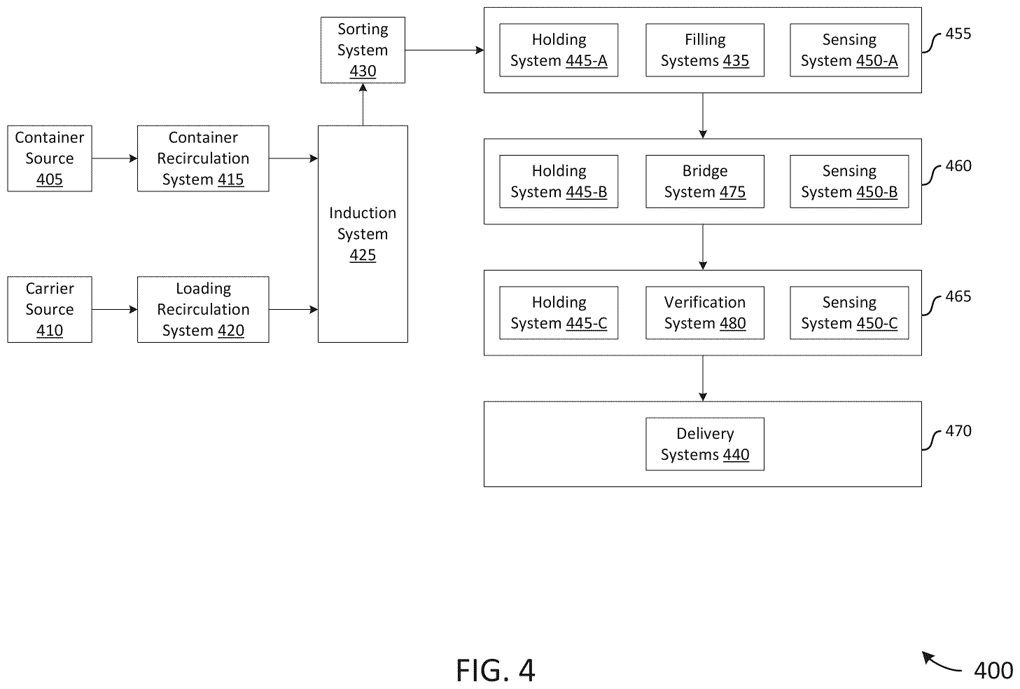

FIG. 4 provides an example fulfillment system 400 in accordance with some embodiments discussed herein. The fulfillment system 400 may be an example of one or more aspects of the system 100. Although the example fulfillment system 400 depicts a particular arrangement of components, the arrangement may be altered without departing from the scope of the present disclosure. For example, some components of the fulfillment system 400 may be omitted and other components that are not shown may be added to the fulfillment system 400. As an illustrative example, one or more components of the fulfillment system 400 may be controlled by a data analysis system 101, a computing entity (e.g., a computing entity 106, an external computing entity 102), or any other type of controller or processor not shown in FIG. 4. Additionally, various components of the fulfillment system 400 may be arranged in a different order than the order shown.

The fulfillment system 400 may include one or more components, which may be physically coupled, electronically coupled (e.g., in communication with one another), or both. For example, the container source 405 may be physically coupled with one or more recirculation systems, such as a container recirculation system 415 by a portion of a conveyance assembly. Accordingly, the conveyer assembly (e.g., portion thereof) may transport one or more item containers between the container source 405 and the container recirculation system 415. Additionally, or alternatively, various components of the fulfillment system 400 may be communicatively coupled with one another or with one or more other components (not shown), such as a computing entity 106.

In some embodiments, the fulfillment system 400 is a system for handling orders for items. The fulfillment system 400, for example, may include a plurality of logistic components for a distribution center in which items are moved, processed, and grouped in one or more packages to fulfill an order. In this respect, the logistic components may be strategically placed within the distribution center to optimize a throughput, or other logistic considerations, of the fulfillment system 400. Logistic components, for example, may include conveyer assemblies, packaging areas, item processing areas, and/or the like that are configured to efficiently and reliably transition an item from a storage location to an end user. By way of example, a fulfillment system 400 may include a pharmaceutical fulfillment system configured to move pharmaceutical items, such as pill vials, and/or the like, from a storage location to a package that may dispatched to an end user. A pharmaceutical fulfillment system may include various logistic components, such as conveyer assemblies, induction systems 425, sorting systems 430, filling systems 435 (e.g., vial-filling systems), and/or the like that are collectively configured to fill a pill vial and then transport the filled vial to a package in accordance with an order for one or more medications.

In some embodiments, an order is a data entity that describes one or more items for an end user (e.g., an individual person, an organization, such as a pharmacy, etc.). In some examples, an order may be associated with a plurality of items that may originate at one or more different locations within the fulfillment system 400. To fulfill an order, the fulfillment system 400 may group the plurality of items into a common package for dispatch to the end user.

As an example, an order for a pharmaceutical fulfillment system may describe one or more different medications for an end user. In some examples, to originate an item for the order, a plurality of medications, such as pill capsules, may be loaded into one or more vials or other containers. Accordingly, an order may be associated with a plurality of vials, or other containers that each contain a portion of the order (e.g., one of the one or more different medications). To fulfill an order, the pharmaceutical fulfillment system may group the plurality of vials into a common package for dispatch to the end user.

In some embodiments, an end user refers to an originator of an order. An entity may be an individual (e.g., patient, customer, etc.), a business (e.g., pharmacy, clinic, etc.), and/or the like. An end user may be associated with a physical location to which a plurality of different item containers may be delivered to fulfill an order. The item containers may be filled and transported to a delivery location (e.g., a delivery system 440) using a conveyer assembly of the fulfillment system 400.

In some embodiments, a conveyer assembly is a component of the fulfillment system 400 that is configured to move (e.g., through friction or other forces) item containers, container carriers, and/or the like to, from, and/or between one or more locations within the fulfillment system 400. In some examples, a conveyer assembly may include an assembly, arrangement, system, and/or the like that includes a plurality of conveyers. In some examples, a conveyer assembly may include an end-to-end closed conveyance system that is configured to transport (e.g., move, route, etc.) a plurality of objects (e.g., item containers, container carriers, combinations thereof, etc.) between one or more points within a fulfillment system 400. The conveyer assembly may include a plurality of at least partially connected portions, each configured to move a plurality of objects (e.g., item containers, container carriers, combinations thereof, etc.) to, from, and/or between multiple points within the fulfillment system 400. In some examples, one or more portions of the conveyer assembly may be connected by one or more other systems, such as an induction system 425 as described herein.

In some embodiments, a conveyer assembly includes a plurality of portions that respectively correspond to one or more areas within a fulfillment system 400. For instance, each portion may include one or more conveyers that are configured to move an object, directly or indirectly, from an origin location to a destination location associated with a respective area. To do so, each of the one or more portions of the conveyer assembly may include one or more recirculation and/or direct conveyer systems.

As described herein, a recirculation conveyer system (e.g., a container recirculation system 415, a loading recirculation system 420) may include an at least partially looped conveyer in which an object may complete one or more recirculation cycles without moving from a portion of the conveyer assembly. A direct conveyer system may include a directed section of conveyer that moves an object from an origin to a destination location. An object may be moved between portions of the conveyer assembly using the direct conveyer systems. For example, a direct conveyer system may include an induction exiting system configured to move an item container, a container carrier, and/or one or more combinations thereof from an induction system 425 to a subsequent portion of a conveyer assembly (e.g., a sorting system 430).

Various embodiments described herein provide a conveyer assembly that provides advantages when compared to conventional conveyer systems. For example, the conveyer assembly may be configured to facilitate more efficient, effective, and accurate processing of connected orders, such as pharmaceutical orders, in which a plurality of small objects are aggregated, transported, and collectively packaged for a single end user. For example, the conveyer assembly described herein may include one or more components that decrease cycle time, reduce operational costs, and otherwise improve sorting and tracking of orders. To do so, the conveyer assembly may include one or more continuous flow systems (e.g., recirculation systems) that enable the continuous circulation and routing of compatible objects (e.g., item containers, container carriers, etc.). By maintaining a continuous movement of the objects, the conveyer assembly may leverage forces exerted by the object themselves to replace traditional electronically controlled gates with mechanical routing mechanisms, which reduces system complexity, maintenance costs, and cycle time, while conserving processing resources, and improving overall system throughput as well as energy efficiency.

In some embodiments, a conveyer is a component of the conveyer assembly. A conveyer may include one or more moving surfaces (e.g., one or more belts, one or more rollers, etc.), which may exert one or more directional forces on one or more objects placed on the conveyer. In some examples, a conveyer may be controlled by a control system. It should be understood that a conveyer or conveyer belt, as described herein, may be configured as a conventional conveyer belt, such that it is formed and/or extended around at least two driving wheels. By turning the driving wheels, the conveyer belt may run cyclically (e.g., continuously around the driving wheels). The conveyer belt may thus, like conventional belts of this nature, be made from a multitude of materials, linkages, and so forth, so as to achieve the desired combination of durability and flexibility thereof.

In some embodiments, an item container is a physical object with an interior portion defined by a plurality of exterior walls that is designed to contain one or more items. An item container, for example, may include a package, tote, box, tube, and/or the like for containing a plurality of items in a common space. In some examples, an item container may define a closed interior portion to contain the plurality of items in a closed environment.

As an example, in a pharmaceutical fulfillment system, an item container may include a vial, such as a pill vial for holding a plurality of pill capsules. A vial, for example, may include a cylindrical container with curved sidewalls, a floor, and a removeable cap disposed opposite to the floor that define an interior portion of the vial. As described herein, the interior portion of the vial may be at least partially filled with a plurality of items, such as pill capsules, to group and then collectively move the plurality of items across the pharmaceutical fulfillment system.

In some examples, an item container, such as a pill vial, may include a small item that may be unstable (e.g., subject to falling, rolling, etc.) and/or difficult to track across a fulfillment system. In accordance with some embodiments of the present disclosure, to improve the stability and/or trackability of an item container as it is moved across the fulfillment system, an item container may be temporarily placed at least partially within an interior portion of another, larger object. For instance, an item container may be placed within a container carrier.

The fulfillment system 400 may include one or more container sources 405. A container source 405 may be an example of an area or a component that introduces item containers to the fulfillment system 400. In some examples, a container source 405 may refer to a region of the fulfillment system 400 where item containers are loaded onto one or more conveyers. A container source 405 may be coupled with one or more other subcomponents of a fulfillment system 400, such as a container recirculation system 415. In some examples, the container source 405 may be coupled with the container recirculation system 415 via one or more conveyers.

The fulfillment system 400 may include one or more carrier sources 410. A carrier source 410 may be an example of an area or a component that introduces container carriers into the fulfillment system 400. In some examples, a carrier source 410 may refer to a region of a fulfillment system 400, such as an overflow recirculation system, where container carriers are recirculated, stored, and/or otherwise sourced to one or more other portions of a closed conveyance system. For example, an item container may be unloaded from a container carrier (e.g., for delivering to a customer), and the container carrier may be conveyed to the carrier source 410. The carrier source 410 may accumulate container carriers and convey the container carriers into a loading recirculation system 420 (e.g., for delivery to an induction system 425). Accordingly, container carriers may be recycled or otherwise reused once item containers have been delivered.

In some embodiments, a container carrier is a physical object with an interior portion defined by one or more of interior walls and an exterior portion defined by one or more of exterior walls. A container carrier, for example, may include an interior portion that is compatible with an item container. For example, a diameter, length, and/or the like of the interior portion may be based on a diameter, length, and/or the like of an item container such that the item container may be placed within the interior portion. In addition, or alternatively, the container carrier may include an exterior portion that is larger than the item container to add stability to the item container as it traverses a fulfillment system 400. A container carrier, for example, may be used to hold, support, and/or the like one or more item containers.

By way of example, a container carrier may be an example of a puck (e.g., a transportation puck) that is compatible with a vial. A transportation puck may include cylindrical exterior and/or interior portions. For instance, the transportation puck may be cylindrical and may include a cylindrical cavity (e.g., the interior portion) where a vial may be placed. In this respect, a diameter of the interior portion may be based on a diameter of a vial. In some other examples, a transportation puck may include a plurality of cylindrical cavities, where each cylindrical cavity may hold a respective vial. Although some pucks may be cylindrical, other puck geometries may be utilized. For example, a puck may be rectangular or square.

In some embodiments, a container carrier includes one or more tracking mechanisms for identifying a location of the container carrier (and/or an item container, a plurality of items therein, etc.) within the fulfillment system 400. The one or more tracking mechanisms, for example, may include one or more radio-frequency identification (RFID) tags, barcodes, and/or the like.

In some embodiments, a carrier container pair is a container carrier with an item container placed at least partially therein. A carrier container pair may be transported across the fulfillment system 400 to move and track an item container (and/or a plurality of items therein). In some examples, a carrier container pair may be originated by an induction system 425 that is configured to place an item container at least partially within a container carrier.

To facilitate the continuous pairing (e.g., marriage) of item containers with respective container carriers, the fulfillment system 400 may include one or more recirculation systems that are configured to provide a continuous supply of item containers and container carriers to a plurality of induction systems 425. For example, the fulfillment system 400 may include one or more container recirculation systems 415 for recirculating item containers and/or one or more carrier recirculation systems (e.g., overflow recirculation systems, loading recirculation systems 420) for recirculating container carriers with respect to one or more induction systems 425.

In some embodiments, a recirculation system is a configuration of conveyers within a conveyer assembly that transport, convey, etc. an object along a looped (e.g., continuous) path. Stated another way, a recirculation system may transport an object from an origin location to one or more other points and then back to the origin location. An object in a recirculation system may follow a circular path or an irregular, non-circular path. To do so, a recirculation system may have one of one or more different configurations. A first configuration may include a plurality of conveyers placed at one or more angles to collectively form a looped path. In addition, or alternatively, a second configuration may include two sets of conveyers that move in opposite directions. For instance, the second configuration may include a first set of linear conveyers and a second set of linear conveyers that may apply opposite directional forces to objects disposed on a surface of the respective sets of linear conveyers. The first set of conveyers may be adjacent to the second set of conveyers such that an object may be moved (e.g., by a making contact with a partition, by one or more looped conveyers, etc.) from the first set of conveyers to the second set of conveyers. The first set of conveyers may be configured to transport objects in a first direction and the second set of conveyers may be configured to transport objects in a second direction parallel to and opposite of the second direction to form a continuous loop with the first set of conveyers.

In one illustrative example of the second configuration, an object may travel on the first set of conveyers in the first direction until the object is slid or is pushed (e.g., by another object, by a partitioning wall, by one or more looped conveyers, etc.) onto the second set of conveyers. The second set of conveyers may then move the object in the second, opposite direction. In such examples, the object may be said to recirculate by way of switching from the first set of conveyers to the second set of conveyers and reversing direction. In some examples, the object may recirculate or otherwise switch between conveyers continuously until the object is moved from both sets of conveyers.

In some embodiments, a recirculation system includes one or more entry and/or exit points. For example, an object may be moved to a recirculation system (e.g., onto a conveyer surface of the recirculation system, etc.) via an entry point and may be moved from the recirculation system via an exit point. An entry point, for example, may include a gate (e.g., a mechanical gate, an electronic gate, etc.), a partitioning wall, and/or the like that may be controlled and/or configured to direct an object to a recirculation system. An exit point may include a gate (e.g., a mechanical gate, an electronic gate, etc.), a partitioning wall, and/or the like that may be controlled and/or configured to direct an object from a recirculation system.

A conveyer assembly may include a plurality of recirculation systems of different types to continuously move objects within one or more portions of the conveyer assembly. For instance, the recirculation systems may include one or more carrier recirculation systems, one or more container recirculation systems 415, one or more holding systems 445-A-C, and/or the like. Each of the recirculation systems may include entry and/or exit points that are configured for a particular task. By way of example, a recirculation system, such as a loading recirculation system 420, and/or a container recirculation system 415 may include a plurality of exit points that are respectively associated with partitioning assemblies configured to leverage a continuous motion of objects (e.g., possible by the cyclic design of the recirculation systems) within the recirculation systems to automatically position the objects with respect to an induction system 425 as the objects exit the recirculation systems.

By way of example, a partitioning assembly may cause an object to be moved from the recirculation system based on a position of the object relative to a width and/or sidewall of the recirculation system. For example, a partitioning assembly may be configured to intercept and route an object located on a portion of a conveyer of a recirculation system (e.g., located along a sidewall of the conveyer or within a certain distance from the sidewall of the conveyer) from the recirculation system (e.g., to a position relative to an induction system 425, etc.).

In some embodiments, a recirculation cycle refers to a movement of an object from an origin location back to the origin location. A recirculation cycle may be completed as an object is moved by an at least partially circular set of conveyers. In addition, or alternatively, a recirculation cycle may be completed by changing a direction of motion of an object by transferring the object between two conveyers operating in opposite directions. By way of example, a recirculation cycle may include one or more changes in a conveyance direction of an object in a recirculation system. For instance, a recirculation cycle may be associated with or correspond to an object moving from a first conveyer (e.g., conveying the object in a first direction) to a second conveyer (e.g., conveying the object in a second direction). An object may complete a recirculation cycle if the object changes direction one or more times to move from an origin location back to the origin location.

In some embodiments, the fulfillment system 400 includes one or more recirculation systems configured to continuously feed a plurality of induction systems 425. The induction systems 425 may be configured to create carrier container pairs by placing item containers fed in by one recirculation system at least partially within container carriers fed in by another recirculation system.

In some embodiments, an induction system 425 is a component of a fulfillment system 400 that is configured to label and then place an item container within a container carrier. An induction system 425, for example, may include an item container labeler, such as a vial labeler, that is configured to adhere a label to an item container that describes one or more contents (e.g., a plurality of items) within and/or assigned to the item container. By way of example, an induction system 425 may receive an empty item container, print a label for the item container, apply the label to the item container, and then drop the item container into a container carrier for transportation to a location for filling the item container with one or more items described by the item label.

An induction system 425 may include one or more openings for objects to enter and/or exit an interior chamber of the induction system 425 (e.g., a labeling chamber, etc.). The one or more openings, for example, may include an ingress point and an egress point. In some examples, an item container may enter the induction system 425 through an ingress point and exit through the egress point. In some embodiments, an ingress point is located at a top portion of an induction system 425 and an egress point is located at a bottom portion of the induction system 425. An item container may enter the interior chamber of the induction system 425 by dropping through the ingress point. In some examples, an item container may be prevented from dropping through the ingress point in the event that another item container is located within the interior chamber. For instance, a currently loaded item container may act as a barrier to the entrance of a subsequent item container. The subsequent item container may drop (e.g., based on a gravitational force, etc.) into the interior chamber as the currently loaded item container exits the interior chamber. In this manner, the interior chamber of an induction system 425 may continuously cycle through a plurality of item containers.

In some examples, an item container may be held (e.g., using a mechanical arm, gate, trap door, etc.) within an induction system 425 to apply a label to the item container. Once the label is applied, the item container may be dropped through the egress point to exit the induction system 425 and allow the entrance of a subsequent item container.

In some examples, a container carrier may be positioned at a loading position relative to the induction system 425 to receive an item container as the item container exits the induction system 425. By way of example, the loading position may be located below an egress point of the induction system 425 such that an item container may be placed (e.g., dropped, loaded, etc.) within an interior portion of a container carrier as the item container exits the induction system 425.

In some embodiments, an induction system 425 is coupled with one or more other components of a fulfillment system 400 to facilitate a continuous movement of a plurality of item containers and container carriers relative to the induction system 425. The one or more other components, for example, may include one or more partitioning assemblies and/or conveyer systems collectively configured to move an item container to an ingress point and a container carrier to an egress point of an induction system 425. For example, an item container and/or container carrier may be continuously moved by a conveyer system and directed to an ingress and egress point of an induction system 425 by a partitioning assembly. For example, a partitioning assembly (and/or one or more partitioning walls thereof) may cause a formation of a queue of item containers adjacent to an ingress point of an induction system 425. As additional item containers are directed into the queue, one or more item containers in the queue may be pushed into the induction system 425 (e.g., by another item container, the conveyer, or both).

In some embodiments, a container recirculation system 415 refers to a recirculation system that is designed to recirculate item containers at one or more portions of the conveyer assembly. As described herein, a container recirculation system 415 may be configured to recirculate a plurality of item containers such that they complete one or more container recirculation cycles. In some examples, a container recirculation system 415 may include one or more partitioning assemblies that may direct one or more of a plurality of recirculating item containers into one or more loading areas. By doing so, a container recirculation system 415 may cause a continuous movement of item containers to automatically and continuously feed item containers into one or more induction systems 425.

In some embodiments, a carrier recirculation system is a recirculation system that is designed to recirculate container carriers at one or more portions of the conveyer assembly. As described herein, a carrier recirculation system may be configured to recirculate a plurality of container carriers such that they complete one or more carrier recirculation cycles. By doing so, a carrier recirculation system may cause a continuous movement of container carriers to automatically and continuously feed the container carriers into loading positions relative to the one or more induction systems 425.

In some embodiments, a loading recirculation system 420 is a type of a carrier recirculation system. A loading recirculation system 420 may be configured to continuously move container carriers as they are moved into loading positions relative to one or more induction systems 425. For example, a loading recirculation system 420 may include one or more partitioning assemblies that may direct one or more of a plurality of recirculating container carriers into one or more loading areas.

In some examples, a loading recirculation system 420 may exchange container carriers with another carrier recirculation system to complete a carrier recirculation cycle. For instance, a loading recirculation system 420 may receive container carrier from one or more other components of a fulfillment system 400, such as a carrier source 410, which may be another example of a recirculation system. In some examples, a loading recirculation system 420 may receive a plurality of container carriers from an overflow recirculation system. Additionally, or alternatively, the loading recirculation system 420 may move one or more container carriers into the overflow recirculation system (e.g., if the one or more container carriers are not loaded into an induction system 425 during a recirculation cycle).

In some embodiments, the overflow recirculation system is a type of carrier recirculation system. In some examples, an overflow recirculation system may be configured to recirculate a plurality of container carriers received from one or more different portions of a conveyer assembly. For instance, the conveyer assembly may form a closed system with a plurality of container carriers that are leveraged to move item containers to a destination location of the conveyer assembly. After moving the item containers, the plurality of container carriers (e.g., now emptied) may be routed back to a carrier recirculation system to receive another item container to repeat the process. This end-to-end conveyance process may be performed without removing a container carrier from the conveyer assembly.

For example, each container carrier of the closed system conveyer assembly may be ultimately routed to an overflow recirculation system. An overflow recirculation system may continuously move the container carriers until they are needed to move item containers. An overflow recirculation system may then supply one or more loading recirculation systems 420 with a plurality of container carriers. In a high throughput system, this may be a continuous process in which container carriers are continuously moved from an overflow recirculation system to a loading recirculation system 420. In some examples, an overflow recirculation system may receive container carriers back from the loading recirculation system 420 in the event that they are not loaded after a recirculation cycle.

The fulfillment system 400 may include one or more sorting systems 430. In some embodiments, the sorting system 430 refers to a component of a fulfillment system 400. A sorting system 430 may automatically route carrier container pairs to one or more other components of the fulfillment system 400, such as one or more filling systems 435A-B in which item containers may be filled with a respective plurality of items. For example, a sorting system 430 may move a carrier container pair to a manual filling area (e.g., to be filled manually) and/or to an automatic filling system (e.g., to be filled using automation). A sorting system 430 may determine where to move a carrier container pair based on a type of order that the carrier container pair is associated with. For example, some types of orders (e.g., some medication types) may be designated for manual filling and other types of orders may be designated for automatic filling. Additionally, or alternatively, a sorting system 430 may determine where to move a carrier container pair based on availability of a filling system 435A-B. In some examples, a sorting system 430 may receive one or more control signals (e.g., from a control system), which may control the sorting system 430. A sorting system 430 may have one or more openings for objects to enter or exit through. For example, carrier container pairs may be moved into a sorting system 430 via an entry point and out of the sorting system 430 via an exit point. A sorting system 430 may be coupled with one or more other components of a fulfillment system 400, such as one or more portions of the conveyer assembly to facilitate the movement of the carrier container pairs.

In some embodiments, the fulfillment system 400 includes one or more transportation portions. Each transportation portion, for example, may facilitate the movement of the carrier container pairs toward a packaging portion 470 of the fulfillment system.

In some embodiments, the transportation portion may include one or more conveyers (e.g., direct conveyer systems, recirculation conveyer systems, or both) as well as one or more systems that perform various operations for processing item containers, container carriers, or carrier container pairs. In some examples, a fulfillment system 400 may include a plurality of transportation portions that collectively transport carrier container pairs to a packaging transportation portion 470. For example, the fulfillment system 400 may include a filling transportation system 455, a bridge transportation system 460, a verification transportation system 465, and/or the like. In some embodiments, a filling transportation portion 455 is a portion of a conveyer assembly that includes one or more components for filling item containers with one or more items, such as pill counting devices in a pharmaceutical system. For example, the fulfillment system 400 may include one or more container filling systems 435. In some embodiments, a container filling system 435 refers to a component of a fulfillment system 400. A container filling system 435 may include one or more mechanical and/or electrical components for automatically dispersing a plurality of items into an item container. A container filling system 435, for example, may include a hopper for holding a plurality of specific items, a counting chamber for counting a subset of the specific items, and/or a dispensing point through which the subset of the specific items may be dispersed from the container filling system 435. In some examples, a container filling system 435 may include circuitry (e.g., cameras, sensors, memory, processors, etc.) configured to count a specific number of items as they fall through a counting chamber. In this way, a container filling system 435 may dispense a specific number of items into an item container based on the order information corresponding to the item container. In some examples, the filling system 435 may be an example of an automatic filling system or a manual filling system, or vice versa.

In some examples, the filling transportation portion 455 may include one or more container filling systems 435, one or more sensing systems 450 for sensing various characteristics of container carriers, and one or more holding systems 445 for holding or recirculating one or more carrier container pairs. Additionally, or alternatively, the filling transportation portion 455 may include one or more conveyers (e.g., direct conveyer systems, recirculation conveyer systems, or both), which may move objects throughout the filling transportation system 455. As one illustrative example, the holding system 445-A may include a recirculation system, which may be configured to recirculate one or more carrier container pairs within the filling transportation portion 455. In some examples, the filling transportation portion 455 may be coupled with one or more other components of the fulfillment system 400, such as the induction system 425 (e.g., via the sorting system 430) and the bridge transportation portion 460.

In some embodiments, a bridge transportation portion 460 is a portion of a conveyer assembly that includes one or more components (e.g., a bridge system 475 including one or more conveyers, among other examples of components included in the bridge transportation portion 460) for moving carrier container pairs from a filling transportation portion 455 of the fulfillment system 400 to a verification transportation portion 465 of the fulfillment system 400. For example, the bridge transportation portion 460 may include a bridge system 475. The bridge system 475 may include one or more direct conveyer systems configured to transport one or more carrier container pairs from the filling transportation portion 455 to the verification transportation portion 465. Additionally, or alternatively, the bridge transportation portion 460 may include one or more sensing systems 450 for sensing various characteristics of container carriers and one or more holding systems 445 for holding or recirculating one or more carrier container pairs. In some examples, the bridge transportation portion 460 may include one or more recirculation conveyer systems, which may be configured to recirculate one or more carrier container pairs within the bridge transportation portion 460. For example, a holding system 445 of a bridge transportation portion 460 may include one or more recirculation conveyer systems. In some examples, the bridge transportation portion 460 may be coupled with one or more other components of the fulfillment system 400, such as the filling transportation portion 455 and the verification transportation portion 465.

In some embodiments, the verification transportation portion 465 is a portion of a conveyer assembly that includes one or more components, such as a verification system 480, for verifying one or more characteristics of one or more items in the verification transportation portion 465. For example, the verification system 480 may include one or more components for determining if a correct item has been loaded into a respective item container, among other examples. In some examples, the verification system 480 may include one or more inspection stations where one or more carrier container pairs may be temporarily held for manual or automatic inspection. In some examples, the verification system 480 may be configured to verify one or more characteristics of an order. For example, the verification system 480 may be configured to verify if two or more carrier container pairs associated with a same order are adjacent to one another, or if each carrier container pair associated with an order is present (e.g., in the verification transportation portion 465).

The verification transportation portion 465 may include the verification system 480, one or more conveyer systems, one or more sensing systems 450, and one or more holding systems 445. The one or more sensing systems 450 may be configured to sense various characteristics of container carriers and the one or more holding systems 445 may be configured to hold or recirculate one or more carrier container pairs. In some examples, the verification transportation portion 465 may include one or more recirculation conveyer systems, which may be configured to recirculate one or more carrier container pairs within the verification transportation portion 465. For example, the holding system 445-C may include one or more recirculation conveyer systems. In some examples, the verification transportation portion 465 may be coupled with one or more other components of the fulfillment system 400, such as the bridge transportation portion 460 and the packaging transportation portion 470.

The holding systems 445A-C may be located within various different portions of the fulfillment system 400. For example, a first holding system 445-A may be located in the filling transportation portion 455, a second holding system 445-B may be located in the bridge transportation portion 460, a third holding system 445-C may be located in the verification transportation portion 465, and/or the like. In some embodiments, a holding system 445A-C may include a recirculation system within a transportation portion of the fulfillment system 400. For instance, each transportation portion may include one or more holding systems to recirculate objects (e.g., item containers, container carriers, carrier container pairs, etc.) within the transportation portion. By recirculating the objects, a holding system may temporarily “hold” the object within a location of the transportation portion.

As examples, a fulfillment system 400 may include a holding system 445A, a holding system 445B, and a holding system 445C. In some examples, a container carrier may be moved off of a first conveyer (e.g., a direct conveyer system, etc.) and into a holding system 445A-C (e.g., a recirculation system, etc.). A container carrier may be moved off of the first conveyer and into the holding system 445A-C based on a distance-based stimulus. A distance-based stimulus may include an event or catalyst that causes or triggers an object to be moved into a holding system 445, or any other type of diversion area that at least temporarily removes the object from a direct conveyer system. In some examples, the occurrence of a distance-based stimulus may be measured or identified by one or more sensing systems 450. For example, a sensing system 450 may read a location tracking mechanism of a first object at a first time (e.g., when the object passes the sensing system) and read a location tracking mechanism of a second object at a second time (e.g., when the second object passes the sensing system). The sensing system may then determine a distance between the first object and the second object (e.g., based on a speed of a conveyer that moves the first object and the second object, and based on a difference between the second time and the first time). The distance between the first object and the second object satisfying (e.g., being greater than) a threshold distance may be an example of a distance-based stimulus.

In some other examples, a presence or absence of one or more objects in a zone or area may constitute a distance-based stimulus. For example, a sensing system may determine respective locations of each object associated with a same order relative to respective portions (e.g., transportation portions) of a conveyer assembly. If one or more first objects associated with the same order are located in a first portion of a conveyer assembly and one or more second objects associated with the same order are located in a second portion of the conveyer assembly, the one or more first objects may be moved into a holding system 445A-C included in the first portion of the conveyer assembly until the one or more second objects enter the first portion of the conveyer assembly.

In some examples, a distance between two objects being greater than a threshold may constitute a distance-based stimulus. For example, a first object may be separated from a second object by a first distance that is greater than a first distance threshold. In response to the first distance being greater than the first distance threshold, the first object or the second object may be moved to a holding system 445-A (e.g., included in a first portion of a conveyer assembly) until the first distance threshold is achieved (e.g., until the first object and the second object are separated by the first distance threshold). In some examples, the first object and the second object may then be separated by a second distance that is less than the first distance. However, the second distance may be greater than a second distance threshold. Accordingly, the first object or the second object may be moved to the holding system 445-B (e.g., included in a second portion of a conveyer assembly) until a second distance threshold is achieved (e.g., until the first object and the second object are separated by the second distance threshold). The second distance threshold may be less than the first distance threshold.

A holding system 445A-C may include one or more conveyers (e.g., looped conveyers, recirculation systems), which may circulate the container carrier (e.g., hold the container carrier) for a duration. A holding system 445A-C may hold a plurality of container carriers simultaneously. A holding system 445A-C may have one or more openings for objects to enter or exit through. For example, container carriers may be moved into a holding system 445A-C via an entry point and out of the holding system 445 A-C via an exit point. A holding system 445A-C may be coupled, via one or more conveyers, with one or more other subcomponents of a fulfillment system. For example, the holding systems 445A-C may be coupled with one or more respective systems within a respective transportation portion.

In some embodiments, the fulfillment system 400 includes one or more sensing systems 450A-C. The sensing systems 450A-C may be located within various different portions of the fulfillment system 400. For example, a first sensing system 450A may be located in the filling transportation portion 455, a second sensing system 450B may be located in the bridge transportation portion 460, a third sensing system 450C may be located in the verification transportation portion 465, and/or the like.

In some embodiments, a sensing system 450A-C may include a component of the fulfillment system 400. A sensing system 450A-C may include circuitry (e.g., cameras, sensors, memory, processors, etc.) configured to detect, sense, and/or the like a presence of an object, such as item container, container carrier, and/or carrier container pair, at a particular location of the fulfillment system 400 (e.g., a portion of the conveyer assembly). In some examples, a sensing system 450A-C may be configured to detect an object by scanning information associated with the object as the object moves relative to (e.g., over, etc.) a scanning location on a conveyer assembly. For example, a sensing system 450A-C may include an RFID reader configured to receive one or more radio signals emitted by an object and/or a tracking mechanism thereof. By way of example, an object, such as a container carrier, may include one or more tracking mechanisms, such as an RFID tag, barcode, and/or the like. The tracking mechanism may emit an identifying radio signal that may be received by a sensing system 450A-C when the object is within a proximity to the sensing system 450A-C. A sensing system 450A-C may be coupled with one or more components of a fulfillment system 400, such as one or more portions of the conveyer assembly to detect an object as it moves between or through portions of the conveyer assembly.

In some examples, a sensing system 450 may detect or read presence data for a container carrier. Presence data refers to data that is indicative of a container carrier (e.g., a carrier identifier). In some examples, presence data may be raw data. In some other examples, presence data may be encoded data. Presence data may be processed to generate and/or identify an identifier for a container carrier. A container carrier may be detected based on a container carrier identifier. In response to the detection of a container carrier, a location of the container carrier may be updated to a relative location of the sensing system 450 that generated the presence data. The relative location may be stored in a location log with a timestamp.

In some examples, a distance between two container carriers may be determined by comparing locations of the two container carriers in the location log (e.g., past locations with timestamps). In some examples, a location stored in a location log may correspond to a portion of the conveyer assembly (e.g., a portion of the conveyer assembly where the sensing system 450 that detected the presence data is located). For example, a conveyer assembly may include at least one sensing system 450 within each portion of the conveyer assembly. In some examples, each transportation portion of the conveyer assembly may include a sensing system 450 disposed relative to at least one of an ingress and/or egress point of the transportation portion. In this way, the detection of a container carrier may be indicative of whether a container carrier is located within a respective transportation portion.

The fulfillment system 400 may include a packaging transportation portion 470. In some embodiments, the packaging transportation portion 470 is a portion of a conveyer assembly that includes one or more components for delivering or packaging carrier container pairs. For example, the packaging transportation portion 470 may include one or more delivery systems 440, which may be destination locations for one or more item containers. Additionally, or alternatively, the packaging transportation portion 470 may include one or more conveyer systems, which may be configured to move one or more carrier container pairs, one or more item containers (e.g., once removed from respective container carriers), and/or one or more container carriers (e.g., once respective item containers are removed). In some examples, the packaging transportation portion 470 may include one or more components, such as the one or more delivery systems 440, for removing item containers from container carriers. In some examples, the packaging transportation portion 470 may be coupled with one or more other components of the fulfillment system 400, such as the verification transportation portion 465 and the carrier source 410 (e.g., the packaging transportation portion 470 may route empty container carriers back to the carrier source).

In some examples, a delivery system 440 may be a destination location for an item container. In some examples, the one or more delivery systems 440 may be located within the packaging transportation portion 470 of the fulfillment system. At a delivery system 440, an item container may be manually and/or automatically loaded to a delivery package with one or more associated item containers (e.g., associated with a same order). For instance, at a delivery system 440, an item container may be unloaded from a container carrier and placed within a delivery package for dispatching to an end user. A delivery system 440 may be coupled with one or more other components of a fulfillment system 400, such as one or more portions of the conveyer assembly.

### Example Reordering System

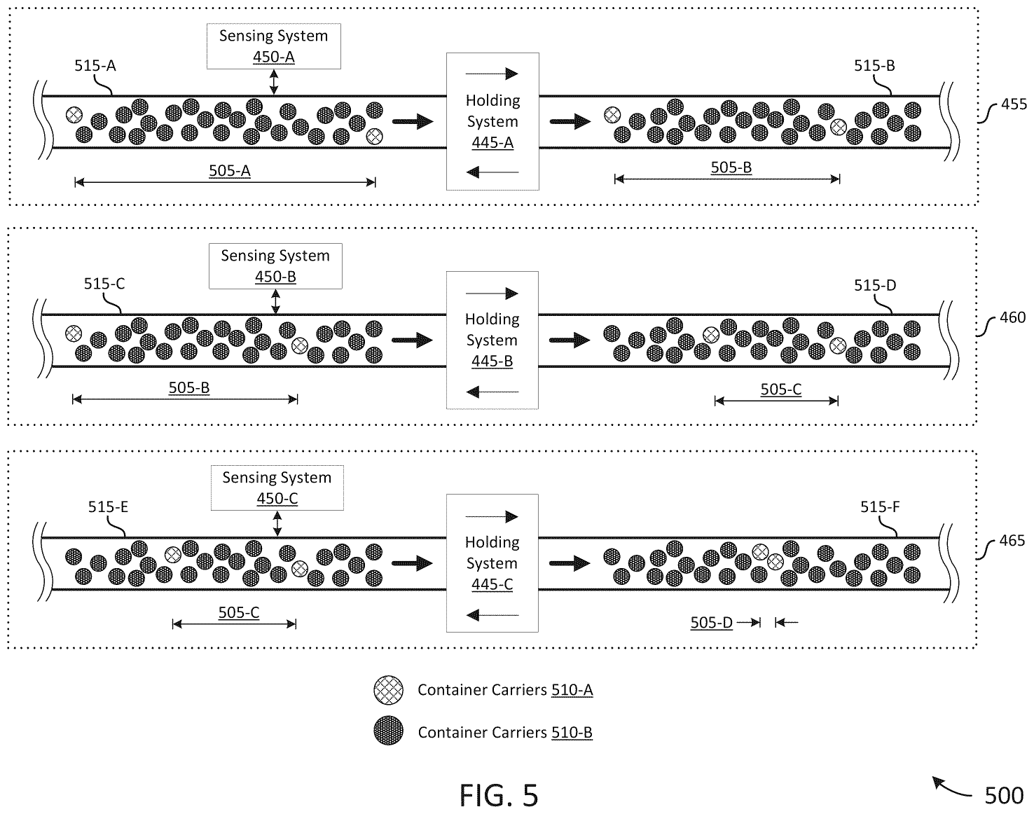

FIG. 5 provides an example reordering system 500 in accordance with some embodiments discussed herein. The reordering system 500 may be an example of one or more aspects of the reordering system 112, as described with reference to FIG. 1. Additionally, or alternatively, the reordering system 500 may include one or more aspects of the fulfillment system 400, as described with reference to FIG. 4. For example, the reordering system 500 may include one or more holding systems 445, one or more sensing systems 450, and one or more conveyers 515, which may be examples of corresponding components described with reference to FIG. 4. For example, the reordering system 500 may include a filling transportation portion 455, a bridge transportation portion 460, and/or a verification transportation portion 465.

Although the example reordering system 500 depicts a particular arrangement of components (e.g., subcomponents), the particular arrangement may be altered without departing from the scope of the present disclosure. For example, some components of the reordering system 500 may be omitted and other components that are not shown may be added to the reordering system 500. As an illustrative example, one or more components of the reordering system 500 may be controlled by a data analysis system 101, a computing entity (e.g., a computing entity 106, an external computing entity 102), or any other type of controller or processor not shown in FIG. 5. Additionally, various components of the reordering system 500 may be arranged in a different order than the order shown. Although the example reordering system 500 illustrates one example of three holding systems 445, any number of holding systems 445 may be utilized. Additionally, or alternatively, any number of sensing systems 450 and any number of conveyers 515 may be utilized.

The reordering system 500 may include one or more components, which may be physically coupled, electronically coupled (e.g., in communication with one another), or both. For example, the holding system 445-A may be physically coupled with the sensing system 450-A. In some examples, the holding system 445-A may hold one or more container carriers 510 based on a distance-based stimulus. For example, the holding system 445-A may hold one or more container carriers 510 if a distance 505-A measured by the sensing system 450-A and communicated to the holding system 445-A is greater than a first distance threshold (e.g., if a first distance threshold is achieved). In some examples, various components of the reordering system 500 may be communicatively coupled with one or more other components (not shown), such as a computing entity 106. For example, one or more sensing systems 450 and one or more holding systems 445 may transmit communications to and receive communications from a computing entity 106.

The reordering system 500 may include one or more conveyers 515 for transporting a plurality of container carriers 510. For example, the conveyer 515-A may transport the plurality of container carriers 510 (e.g., including container carriers 510-A and container carriers 510-B) past the sensing system 450-A (e.g., within a range of the sensing system 450-A) and towards the holding system 445-A. In some examples, a first portion of the container carriers 510 (e.g., one or more of the container carriers 510-A) may be held by the holding system 445-A (e.g., moved into the holding system 445-A) and a second portion of the container carriers 510 (e.g., one or more of the container carriers 510-B) may not be held by the holding system 445-A (e.g., may not be moved into the holding system 445-A). Stated another way, the second portion of the container carriers 510 may be moved from the conveyer 515-A to the conveyer 515-B without entering or being held by the holding system 445-A. A determination may be made as to which container carriers 510 are held by the holding system 445-A. For example, one or more container carriers associated with a specific order (e.g., one or more of container carriers 510-A) may be held while one or more container carriers associated with one or more orders different from the specific order (e.g., container carriers 510-B) may not be held.

The conveyer 515-B may transport the plurality of container carriers 510 (e.g., including container carriers 510-A and container carriers 510-B) away from the holding system 445-A. In some examples, the conveyer 515-B may transport the plurality of container carriers 510 to one or more components of a fulfillment system (e.g., a filling system, among other examples). In some other examples, the conveyer 515-B may transport the plurality of container carriers 510 directly to the conveyer 515-C (e.g., without the container carriers 510 entering any other components).

In some examples, the conveyer 515-A and the conveyer 515-B may be examples of direct conveyer systems. The conveyer 515-A and the conveyer 515-B may be included in a first transportation portion of a conveyer assembly (e.g., a filling transportation portion 455). A transportation portion may be a portion of a conveyer assembly that corresponds to one or more areas within a fulfillment system. A transportation portion may include one or more conveyers 515 (e.g., direct conveyer systems, recirculation conveyer systems, or both) as well as one or more systems that perform various operations for processing item containers, container carriers, or carrier container pairs. In one example, a pharmaceutical fulfillment system may include multiple transportation portions. A first transportation portion (e.g., the filling transportation portion 455) may include a filling system configured to fill item containers, the conveyer 515-A, a recirculation system for recirculating the carrier container pairs (e.g., included in the holding system 445-A), the sensing system 450-A, and the conveyer 515-B.

The reordering system 500 may include one or more sensing systems 450. Each sensing system 450 may perform one or more operations to sense or otherwise scan one or more container carriers 510 within a proximity of the respective sensing system 450. In some examples, a sensing system 450 may read one or more RFID tags, which may be installed or adhered to respective container carriers 510. A sensing system 450 may detect or sense the presence of an object, such as a container carrier 510 or an item container (e.g., an item container in a container carrier 510). A sensing system 450 may be attached to one or more subcomponents of the reordering system 500 (e.g., one or more conveyers 515) and may perform one or more sensing operations as container carriers 510 interact with or pass by the sensing system 450. In some examples, one or more container carriers 510 may enter a sensing system 450. For example, a sensing system 450 may have one or more openings for objects to enter or exit through. In such examples, objects may be moved into a sensing system 450 via an entry point and out of the sensing system 450 via an exit point.

The reordering system 500 may include one or more holding systems 445. A holding system 445 may perform one or more operations to hold or otherwise reorder one or more container carriers 510 (e.g., adjust spacing or distances 505 between container carriers 510). In some examples, a container carrier 510 may be moved off of a conveyer 515 and into a holding system 445. The holding system 445 may include one or more conveyers (e.g., looped conveyers, recirculation systems), which may circulate the container carrier 510 (e.g., hold the container carrier) for a duration. A holding system 445 may hold a plurality of container carriers 510 simultaneously. A holding system 445 may have one or more openings for container carriers 510 to enter or exit through. For example, container carriers 510 may be moved into a holding system 445 via an entry point and out of the holding system 445 via an exit point. A holding system 445 may be coupled with one or more other subcomponents of a fulfillment system, such as one or more conveyers 515.

A holding system 445 may be located at one or more locations within a fulfillment system. For example, a holding system 445 may be located at or otherwise coupled with any section of a conveyer in a fulfillment system. In some examples, a fulfillment system may include a number of holding systems 445, which may work together (e.g., in series) to incrementally adjust a spacing (e.g., a distance 505) between container carriers associated with a same order (e.g., container carriers 510-A). For example, the container carriers 510-A may be separated by a distance 505-A at a first time (e.g., with reference to a tracking point on the conveyer 515-A, as measured by the sensing system 450-A). The holding system 445-A may then hold one or more of the container carriers 510-A for a duration (e.g., for a time period), which may reduce a spacing between the container carriers 510-A. For example, at a second time, after one or more of the container carriers 510-A is output by the holding system 445-A, the container carriers 510-A may be separated by the distance 505-B, which may be less than the distance 505-A. The distance 505-B may be measured by the sensing system 450-B.

The container carriers 510-A may then be moved to the holding system 445-B (e.g., along the conveyer 515-C). The holding system 445-B may then hold one or more of the container carriers 510-A for a duration (e.g., for a time period), which may reduce a spacing (e.g., a distance 505) between the container carriers 510-A. For example, at a third time, after one or more of the container carriers 510-A is output by the holding system 445-B, the container carriers 510-A may be separated by the distance 505-C, which may be less than the distance 505-B. The distance 505-C may be measured by the sensing system 450-B.

In some examples, the conveyer 515-C and the conveyer 515-D may be examples of direct conveyer systems. The conveyer 515-C and the conveyer 515-D may be included in a second portion of a conveyer assembly (e.g., a bridge transportation portion 460). In some examples, the second transportation portion may include a bridge system configured to move item containers from the first transportation portion to a third transportation portion. The second transportation portion may include the bridge system, the conveyer 515-C, a recirculation system for recirculating the carrier container pairs (e.g., included in the holding system 445-B), the sensing system 450-B, and the conveyer 515-D.

The container carriers 510-A may then be moved to the holding system 445-C (e.g., along the conveyer 515-E). The holding system 445-C may then hold one or more of the container carriers 510-A for a duration (e.g., for a time period), which may reduce a spacing (e.g., a distance 505) between the container carriers 510-A. For example, at a fourth time, after one or more of the container carriers 510-A is output by the holding system 445-C, the container carriers 510-A may be separated by the distance 505-D, which may be less than the distance 505-C. In some examples, the distance 505-D may be indicative of the container carriers 510-A being adjacent to one another. Additionally, or alternatively, the conveyer 515-f may move the container carriers 510 out of the fulfillment system or to a delivery system.

In some examples, the conveyer 515-E and the conveyer 515-F may be examples of direct conveyer systems. The conveyer 515-E and the conveyer 515-F may be included in a third portion of a conveyer assembly (e.g., a verification transportation portion 465). The third portion of the conveyer assembly include a verification system configured to perform one or more verification operations for one or more carrier container pairs. The verification system may be an example of a component of a fulfillment system. In some examples, a verification system may include one or more components that facilitate manual inspection of one or more carrier container pairs. Additionally, or alternatively, a verification system may include one or more components that automatically perform one or more verification operations (e.g., using one or more sensing systems, without manual intervention). In one illustrative example, a verification system may include one or more components to verify a distance 505 between two or more carrier container pairs associated with a same order prior to routing the two or more carrier container pairs to a delivery system.

In some examples, the third transportation portion may include a sealing system configured to adhere a seal to a plurality of item containers. The third transportation portion may include the sealing system, the conveyer 515-E, a recirculation system for recirculating the carrier container pairs (e.g., included in the holding system 445-C), the sensing system 450-C, and the conveyer 515-F. The sealing system may be a component of the fulfillment system. In some examples, a scaling system may be included in a portion of a conveyer assembly (e.g., a third portion of a conveyer assembly). A scaling system may be configured to adhere one or more seals to an item container, thereby sealing the item container. In some examples, a type of seal adhered to an item container may depend on the type of the item container. For example, a scaling system may apply one or more of a parafilm seal or a cap (e.g., a twist-off cap) to a pill vial. In some examples, the sealing system may apply a parafilm seal to an item container and attach a cap over the parafilm seal.

Although FIG. 5 shows one illustrative example of three holding systems 445, any quantity of holding systems 445 (and associated sensing systems 450 and conveyers 515) may be utilized in a fulfillment system. For example, a conveyer assembly may include a fourth transportation portion. The fourth transportation portion may include a packaging transportation portion, one or more conveyers 515, one or more sensing systems 450, and one or more holding systems 445. In some embodiments, the packaging transportation portion is a portion of a conveyer assembly that includes one or more components for delivering or packaging carrier container pairs. For example, the packaging transportation portion may include a delivery system, which may be a destination location for one or more item containers. A delivery system may be configured to manually or automatically load one or more item containers into a distribution package. Additionally, or alternatively, the packaging transportation portion may include one or more conveyer systems, which may be configured to move one or more carrier container pairs, one or more item containers (e.g., once removed from respective container carriers), and/or one or more container carriers (e.g., once respective item containers are removed). In some examples, the packaging transportation portion may include one or more components, such as the delivery system, for removing item containers from container carriers. In some examples, the packaging transportation portion may be coupled with one or more other components of a fulfillment system, such as a verification transportation portion and a carrier source (e.g., the packaging transportation portion may route empty container carriers back to the carrier source).

As described herein, container carriers 510-A being adjacent to one another upon being output by the holding system 445-C (e.g., to the delivery system) may reduce operational costs and improve processing efficiency of the fulfillment system. For example, reordering and locating container carriers 510-A (e.g., container carriers 510 associated with a same order) adjacent to one another prior to outputting the container carriers 510-A may eliminate the need for container carriers 510-A to be manually reordered subsequently to being output from the reordering system 500. Additionally, or alternatively, the reordering system 500 may enable container carriers 510 associated with a same order to be incrementally reordered as they are conveyed throughout a fulfillment system (e.g., at times when other operations or tasks could not be performed), which may improve efficiency of the fulfillment system.

### Example Reordering System Process Flow

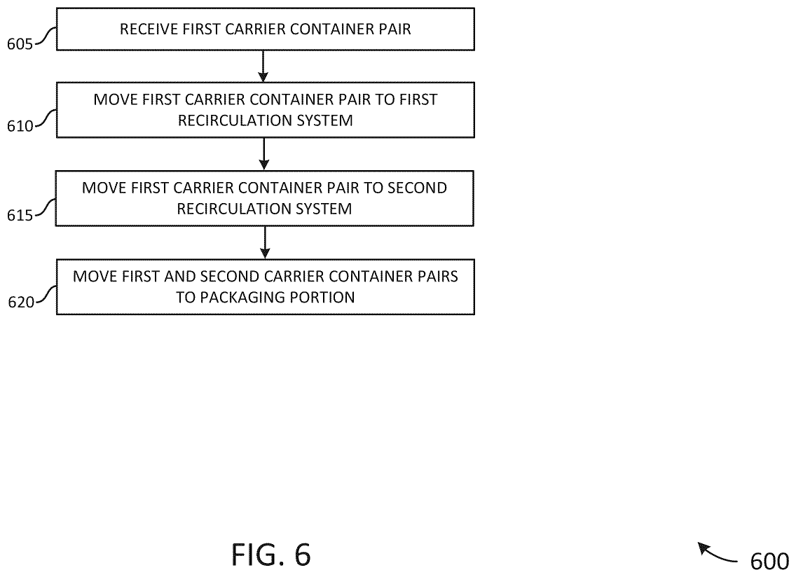

FIG. 6 is a flowchart showing an example of a distance optimization process in accordance with some embodiments discussed herein. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

One or more operations of the process 600 may be implemented or caused by one or more components of a fulfillment system (e.g., a fulfillment system 400). The fulfillment system, as described herein, may be an example of a processing system, a delivery system, a manufacturing system, or any other type of system utilized for sorting, packaging, and delivering pharmaceutical orders. In some examples, the operations described herein may be performed by a system described with reference to FIG. 5, such as a holding system, a sensing system, a conveyer, or any other component of a reordering system.

In some embodiments, the process 600 includes, at step/operation 605, receiving, at a conveyer assembly comprising a first transportation portion, a second transportation portion, and a packaging portion, a first carrier container pair associated with a distribution package and comprising a container carrier and an item container disposed within an interior portion of the container carrier.

In some embodiments, the process 600 includes, at step/operation 610, responsive to a first distance-based stimulus associated with the first transportation portion of the conveyer assembly, moving, using the first transportation portion of the conveyer assembly, the first carrier container pair to a first recirculation system within the first transportation portion of the conveyer assembly to recirculate the first carrier container pair until a first distance threshold is achieved.

In some embodiments, the process 600 includes, at step/operation 615, responsive to a second distance-based stimulus associated with the second transportation portion of the conveyer assembly, moving, using the second transportation portion of the conveyer assembly, the first carrier container pair to a second recirculation system within the second transportation portion of the conveyer assembly to recirculate the first carrier container pair until a second distance threshold is achieved.

In some embodiments, the process 600 includes, at step/operation 620, moving the first carrier container pair and a second carrier container pair associated with the distribution package to the packaging portion of the conveyer assembly based on the second distance threshold.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A method, the method comprising receiving, at a conveyer assembly comprising a first transportation portion, a second transportation portion, and a packaging portion, a first carrier container pair associated with a distribution package and comprising a container carrier and an item container disposed within an interior portion of the container carrier; responsive to a first distance-based stimulus associated with the first transportation portion of the conveyer assembly, moving, using the first transportation portion of the conveyer assembly, the first carrier container pair to a first recirculation system within the first transportation portion of the conveyer assembly to recirculate the first carrier container pair until a first distance threshold is achieved; responsive to a second distance-based stimulus associated with the second transportation portion of the conveyer assembly, moving, using the second transportation portion of the conveyer assembly, the first carrier container pair to a second recirculation system within the second transportation portion of the conveyer assembly to recirculate the first carrier container pair until a second distance threshold is achieved; and moving the first carrier container pair and a second carrier container pair associated with the distribution package to the packaging portion of the conveyer assembly based on the second distance threshold.

Example 2. The method of example 1, wherein the second carrier container pair comprises a secondary container carrier and a secondary item container disposed within an interior portion of the secondary container carrier.

Example 3. The method of example 1, wherein the first carrier container pair and the second carrier container pair are associated with an order for a single end user.

Example 4. The method of example 1, further comprising: receiving, at the conveyer assembly, the second carrier container pair, wherein the first distance-based stimulus and the second distance-based stimulus are based on a distance between the first carrier container pair and the second carrier container pair.

Example 5. The method of example 1, wherein the first transportation portion comprises a filling system configured to fill the item container with one or more items.

Example 6. The method of example 1, wherein the first distance-based stimulus indicates that (i) the first carrier container pair and the second carrier container pair are separated by at least the first distance threshold or (ii) the second carrier container pair is not located in the first transportation portion.

Example 7. The method of example 1, wherein the second transportation portion comprises a bridge system configured to move the item container from the first transportation portion to a third transportation portion.

Example 8. The method of example 1, wherein the second distance-based stimulus indicates that (i) the first carrier container pair and the second carrier container pair are separated by at least the second distance threshold or (ii) the second carrier container pair is not located in the second transportation portion.

Example 9. The method of example 1, wherein the conveyer assembly further comprises a third transportation portion, the third transportation portion comprising a sealing system configured to adhere a seal to the item container.

Example 10. The method of example 1, wherein the conveyer assembly further comprises a fourth transportation portion, the fourth transportation portion comprising (i) a verification system configured to perform one or more verification operations for the first carrier container pair and (ii) a third recirculation system.

Example 11. The method of example 10, further comprising: responsive to a third distance-based stimulus associated with the fourth transportation portion of the conveyer assembly, moving, using the fourth transportation portion of the conveyer assembly, the first carrier container pair to the third recirculation system to recirculate the first carrier container pair until a third distance threshold is achieved.

Example 12. The method of example 1, wherein the first recirculation system is configured to move the first carrier container pair along a looped conveyer until the first distance threshold is achieved.

Example 13. The method of example 1, wherein an induction system outputs a third carrier container pair into the first transportation portion after outputting the first carrier container pair and before outputting the second carrier container pair, wherein the third carrier container pair is associated with a secondary distribution package.

Example 14. The method of example 1, wherein the container carrier comprises a first location tracking mechanism and a secondary container carrier of the second carrier container pair comprises a second location tracking mechanism.

Example 15. The method of example 14, wherein: (i) the first distance threshold is achieved based on a comparison between (a) a distance between the first carrier container pair and the second carrier container pair and (b) the first distance threshold; (ii) the distance is based on one or more carrier detections associated with the first carrier container pair and the second carrier container pair; and (iii) each of the one or more carrier detections are based on presence data generated using one or more sensing systems of the conveyer assembly by reading at least one of the first location tracking mechanism or the second location tracking mechanism at a relative location of the conveyer assembly.

Example 16. The method of example 15, wherein: (i) each of the one or more carrier detections identify a respective transportation portion of the conveyer assembly; (ii) the distance between the first carrier container pair and the second carrier container pair comprises a relative distance that identifies whether the first carrier container pair and the second carrier container pair are located in a same transportation portion; and (iii) the first distance threshold is achieved when the first carrier container pair and the second carrier container pair are located in the first transportation portion.

Example 17. A system, the system comprising an induction system configured to: load, at a first time, a first item container into a first container carrier of a plurality of container carriers to create a first carrier container pair associated with an order; load, at a second time, a second item container into a second container carrier of the plurality of container carriers to create a second carrier container pair that is (i) associated with the order and (ii) spatially separated from the first carrier container pair by a first distance that exceeds a first distance threshold; and a conveyer assembly comprising: a first transportation portion coupled with the induction system and comprising a first recirculation system, wherein the first transportation portion is configured to, responsive to a first distance-based stimulus, move the first carrier container pair to the first recirculation system until the first distance threshold is achieved; and a second transportation portion coupled with the first transportation portion and comprising a second recirculation system, wherein the second transportation portion is configured to, responsive to a second distance-based stimulus, move the second carrier container pair to the second recirculation system until the second distance threshold is achieved.

Example 18. The system of example 17, wherein: (i) the first transportation portion comprises one or more sensing systems configured to generate presence data associated with the first carrier container pair and the second carrier container pair by reading at least one of a first location tracking mechanism or a second location tracking mechanism of the first carrier container pair and the second carrier container pair, and (ii) the first distance threshold is achieved in response to one or more carrier detections based on the presence data.

Example 19. The system of example 17, wherein the first transportation system comprises a filling system configured to fill the first item container with one or more first items and fill the second item container with one or more second items.

Example 20. A conveyer assembly, the conveyer assembly comprising a first transportation portion comprising a first recirculation system and configured to: receive a first carrier container pair associated with a distribution package and comprising a container carrier and an item container disposed within an interior portion of the container carrier; and responsive to a first distance-based stimulus, move the first carrier container pair to the first recirculation system to recirculate the first carrier container pair until a first distance threshold is achieved; a second transportation portion comprising a second recirculation system and configured to: responsive to a second distance-based stimulus, move the first carrier container pair to the second recirculation system to recirculate the first carrier container pair until a second distance threshold is achieved; and a packaging portion configured to receive the first carrier container pair and a second carrier container pair associated with the distribution package based on the second distance threshold.

1. A method comprising:
receiving, at a conveyer assembly comprising a first transportation portion, a second transportation portion, and a packaging portion, a first carrier container pair associated with a distribution package and comprising a container carrier and an item container disposed within an interior portion of the container carrier;
responsive to a first distance-based stimulus associated with the first transportation portion of the conveyer assembly, moving, using the first transportation portion of the conveyer assembly, the first carrier container pair to a first recirculation system within the first transportation portion of the conveyer assembly to recirculate the first carrier container pair until a first distance threshold is achieved;
responsive to a second distance-based stimulus associated with the second transportation portion of the conveyer assembly, moving, using the second transportation portion of the conveyer assembly, the first carrier container pair to a second recirculation system within the second transportation portion of the conveyer assembly to recirculate the first carrier container pair until a second distance threshold is achieved; and
moving the first carrier container pair and a second carrier container pair associated with the distribution package to the packaging portion of the conveyer assembly based on the second distance threshold.

2. The method of claim 1, wherein the second carrier container pair comprises a secondary container carrier and a secondary item container disposed within an interior portion of the secondary container carrier.

3. The method of claim 1, wherein the first carrier container pair and the second carrier container pair are associated with an order for a single end user.

4. The method of claim 1, further comprising:
receiving, at the conveyer assembly, the second carrier container pair, wherein the first distance-based stimulus and the second distance-based stimulus are based on a distance between the first carrier container pair and the second carrier container pair.

5. The method of claim 1, wherein the first transportation portion comprises a filling system configured to fill the item container with one or more items.

6. The method of claim 1, wherein the first distance-based stimulus indicates that (i) the first carrier container pair and the second carrier container pair are separated by at least the first distance threshold or (ii) the second carrier container pair is not located in the first transportation portion.

7. The method of claim 1, wherein the second transportation portion comprises a bridge system configured to move the item container from the first transportation portion to a third transportation portion.

8. The method of claim 1, wherein the second distance-based stimulus indicates that (i) the first carrier container pair and the second carrier container pair are separated by at least the second distance threshold or (ii) the second carrier container pair is not located in the second transportation portion.

9. The method of claim 1, wherein the conveyer assembly further comprises a third transportation portion, the third transportation portion comprising a sealing system configured to adhere a seal to the item container.

10. The method of claim 1, wherein the conveyer assembly further comprises a fourth transportation portion, the fourth transportation portion comprising (i) a verification system configured to perform one or more verification operations for the first carrier container pair and (ii) a third recirculation system.

11. The method of claim 10, further comprising:
responsive to a third distance-based stimulus associated with the fourth transportation portion of the conveyer assembly, moving, using the fourth transportation portion of the conveyer assembly, the first carrier container pair to the third recirculation system to recirculate the first carrier container pair until a third distance threshold is achieved.

12. The method of claim 1, wherein the first recirculation system is configured to move the first carrier container pair along a looped conveyer until the first distance threshold is achieved.

13. The method of claim 1, wherein an induction system outputs a third carrier container pair into the first transportation portion after outputting the first carrier container pair and before outputting the second carrier container pair, wherein the third carrier container pair is associated with a secondary distribution package.

14. The method of claim 1, wherein the container carrier comprises a first location tracking mechanism and a secondary container carrier of the second carrier container pair comprises a second location tracking mechanism.

15. The method of claim 14, wherein:
(i) the first distance threshold is achieved based on a comparison between (a) a distance between the first carrier container pair and the second carrier container pair and (b) the first distance threshold;
(ii) the distance is based on one or more carrier detections associated with the first container carrier pair and the second container carrier pair; and
(iii) each of the one or more carrier detections are based on presence data generated using one or more sensing systems of the conveyer assembly by reading at least one of the first location tracking mechanism or the second location tracking mechanism at a relative location of the conveyer assembly.

16. The method of claim 15, wherein:
(i) each of the one or more carrier detections identify a respective transportation portion of the conveyer assembly;
(ii) the distance between the first carrier container pair and the second carrier container pair comprises a relative distance that identifies whether the first carrier container pair and the second carrier container pair are located in a same transportation portion; and
(iii) the first distance threshold is achieved when the first container carrier pair and the second carrier container pair are located in the first transportation portion.

17. A system comprising:
an induction system configured to:
load, at a first time, a first item container into a first container carrier of a plurality of container carriers to create a first carrier container pair associated with an order;
load, at a second time, a second item container into a second container carrier of the plurality of container carriers to create a second carrier container pair that is (i) associated with the order and (ii) spatially separated from the first carrier container pair by a first distance that exceeds a first distance threshold; and
a conveyer assembly comprising:
a first transportation portion coupled with the induction system and comprising a first recirculation system, wherein the first transportation portion is configured to, responsive to a first distance-based stimulus, move the first carrier container pair to the first recirculation system until the first distance threshold is achieved; and
a second transportation portion coupled with the first transportation portion and comprising a second recirculation system, wherein the second transportation portion is configured to, responsive to a second distance-based stimulus, move the second carrier container pair to the second recirculation system until the second distance threshold is achieved.

18. The system of claim 17, wherein:
(i) the first transportation portion comprises one or more sensing systems configured to generate presence data associated with the first carrier container pair and the second carrier container pair by reading at least one of a first location tracking mechanism or a second location tracking mechanism of the first carrier container pair and the second carrier container pair, and
(ii) the first distance threshold is achieved in response to one or more carrier detections based on the presence data.

19. The system of claim 17, wherein the first transportation system comprises a filling system configured to fill the first item container with one or more first items and fill the second item container with one or more second items.

20. A conveyer assembly comprising:
a first transportation portion comprising a first recirculation system and configured to:
receive a first carrier container pair associated with a distribution package and comprising a container carrier and an item container disposed within an interior portion of the container carrier; and
responsive to a first distance-based stimulus, move the first carrier container pair to the first recirculation system to recirculate the first carrier container pair until a first distance threshold is achieved;
a second transportation portion comprising a second recirculation system and configured to:
responsive to a second distance-based stimulus, move the first carrier container pair to the second recirculation system to recirculate the first carrier container pair until a second distance threshold is achieved; and
a packaging portion configured to receive the first carrier container pair and a second carrier container pair associated with the distribution package based on the second distance threshold.
